(19) United States
(12) Patent Application Publication
(10) Pub. No.: US 2004/0152591 A1
(43) Pub. Date: Aug. 5, 2004

(54) Polymerized metallocene catalyst composition

(76) Inventors: Guo-Xin Jin, Shanghai (CN); William M. Chien, Houston, TX (US); Zerong Lin, Kingwood, TX (US); Robert J. Wittenbrink, Kingwood, TX (US); Guangyuan Zhou, Louvain-La-neuve (BE)

Correspondence Address: EXXONMOBIL CHEMICAL COMPANY, P O BOX 2149, BAYTOWN, TX, 77522-2149, US

(21) Appl. No.: 10/693,786

(22) Filed: Oct. 24, 2003

Related U.S. Application Data
(60) Provisional application No. 60/433,934, filed on Dec. 17, 2002.
(60) Provisional application No. 60/434,082, filed on Dec. 17, 2002.
(60) Provisional application No. 60/421,282, filed on Oct. 25, 2002.
(60) Provisional application No. 60/421,163, filed on Oct. 25, 2002.
(60) Provisional application No. 60/421,164, filed on Oct. 25, 2002.
(60) Provisional application No. 60/434,913, filed on Dec. 20, 2002.
(60) Provisional application No. 60/435,228, filed on Dec. 20, 2002.
(60) Provisional application No. 60/435,046, filed on Dec. 20, 2002.
(60) Provisional application No. 60/446,607, filed on Feb. 12, 2003.

(51) Int. Cl. B01J 31/00; C08F 4/44

(52) U.S. Cl. 502/152; 502/102; 502/103; 502/117; 502/108; 526/227; 526/229; 526/346; 526/335; 526/901; 526/160; 526/943

(57) ABSTRACT

Free-radical-initiated copolymerization of metallocene complexes containing olefinic substituents on aryl groups with styrene results in polymerized late transition metal catalysts that can be used for olefin polymerization or oligomerization. These catalysts have high catalyst activity for olefin polymerization or oligomerization.

### STATEMENT OF RELATED APPLICATIONS

This application claims priority from U.S. Ser. No. 60/433,934 filed Dec. 17, 2002 and U.S. S No. 60/434,082 filed Dec. 17, 2002. This application is related to U.S. S No. 60/421,282 filed Oct. 25, 2002; U.S. S No. 60/421,163 filed Oct. 25, 2002; U.S. S No. 60/421,164 filed Oct. 25, 2002; U.S. S No. 60/434,913 filed Dec. 20, 2002; U.S. S No. 60/435,228 filed Dec. 20, 2002; U.S. S No. 60/435,046 filed Dec. 20, 2002 and U.S. S No. 60/446,607 filed Feb. 11, 2003.

### FIELD OF THE INVENTION

This invention relates to methods of polymerizing or oligomerizing one or more olefins using one or more activators with one or more polymerized catalyst compounds prepared by polymerizing (using a free radical initiator) one or more free radical polymerizable monomers (such as styrene) with one or more different catalyst precursors containing terminal unsaturation.

### BACKGROUND

U.S. Pat. No. 5,714,425 describes metallocene catalyst compositions having a polymerizable olefinic group. These metallocenes are described as being useful to prepare polyolefins. In addition, these metallocenes are described as being polymerized with one or more alpha-olefins so that the metallocene is copolymerized with the alpha-olefin. This composition is then described as useful to polymerize olefins. But U.S. Pat. No. 5,714,4254 does not disclose free-radical polymerization of catalyst compositions having a polymerizable olefinic group with monomers such as styrene, isobutylene, 1,3-butadiene and the like.

U.S. Pat. No. 5,679,816 discloses biscyclopentadienyl transition-metal complexes containing a conjugated diene ligand group.

U.S. Pat. No. 6,150,544 and U.S. Pat. No. 6,352,953 disclose bimetallic, metallacyclic catalyst compounds where one metal is a Group-4 metal and the other metal is a Group-3 metal. (Likewise, it is also known in the art to prepolymerize a heterogeneous catalyst system in the presence of at least one olefin see EPA 426,646 and U.S. Pat. No. 4,871,705.)

### SUMMARY

This invention relates to a composition comprising the product of combining, in the presence of a free radical initiator, one or more monomers that can be polymerized by a free radical initiator and a catalyst precursor represented by the formula:

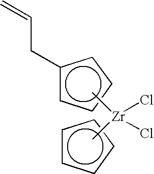

or

L₂MX₂, as further described below.

This invention also relates to methods to polymerize olefins using the above composition.

### DETAILED DESCRIPTION

### Definitions

The term “hydrocarbyl radical” is sometimes used interchangeably with “hydrocarbyl” throughout this document. For purposes of this disclosure, “hydrocarbyl radical” encompasses C1-C200 radicals. These radicals can be linear, branched, or cyclic, and when cyclic, aromatic or non-aromatic. Thus, the term “hydrocarbyl radical”, in addition to unsubstituted hydrocarbyl radicals, encompasses substituted hydrocarbyl radicals, halocarbyl radicals, and substituted halocarbyl radicals, as these terms are defined below.

Substituted hydrocarbyl radicals are radicals in which at least one hydrogen atom has been replaced with a functional group such as NR″2, OR″, PR″2, SR″, BR″2, SiR″3, GeR″3 and the like or where at least one non-hydrocarbon atom or group has been inserted within the hydrocarbyl radical, such as O, S, NR″, PR″, BR″, SiR″2, GeR″2, and the like, where R″ is independently a C1-C30 hydrocarbyl or halocarbyl radical.

Halocarbyl radicals are radicals in which one or more hydrocarbyl hydrogen atoms have been substituted with at least one halogen or halogen-containing group (e.g. F, Cl, Br, I).

Substituted halocarbyl radicals are radicals in which at least one hydrocarbyl hydrogen or halogen atom has been substituted with a functional group such as NR″2, OR″, PR″2, SR″, BR″2, SiR″3, GeR″3 and the like or where at least one non-carbon atom or group has been inserted within the halocarbyl radical such as O, S, NR″, PR″, BR″, SiR″2, GeR″2, and the like where R″ is independently a C1-C30 hydrocarbyl or halocarbyl radical if at least one halogen atom remains on the original halocarbyl radical.

In some embodiments, a hydrocarbyl radical is independently selected from methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, propenyl, butenyl, pentenyl, hexenyl, heptenyl, octenyl, nonenyl, decenyl, undecenyl, dodecenyl, tridecenyl, tetradecenyl, pentadecenyl, hexadecenyl, heptadecenyl, octadecenyl, nonadecenyl, eicosenyl, heneicosenyl, docosenyl, tricosenyl, tetracosenyl, pentacosenyl, hexacosenyl, heptacosenyl, octacosenyl, nonacosenyl, triacontenyl, propynyl, butynyl, pentynyl, hexynyl, heptynyl, octynyl, nonynyl, decynyl, undecynyl, dodecynyl, tridecynyl, tetradecynyl, pentadecynyl, hexadecynyl, heptadecynyl, octadecynyl, nonadecynyl, eicosynyl, heneicosynyl, docosynyl, tricosynyl, tetracosynyl, pentacosynyl, hexacosynyl, heptacosynyl, octacosynyl, nonacosynyl, or triacontynyl isomers. The radical may then be subjected to the types of substitutions described above.

Ancillary ligands serve to enforce the geometry around the metal center. In most cases invention ancillary ligands comprise a cyclopentadienyl group. A cyclopentadienyl group is defined as an aromatic ring system or fused ring system that contains at least one aromatic C5 structure. In some cases throughout the specification and claims a cyclopentadienyl group will be shown as a C5 group. When this is so, any C5-containing group is intended, not just cyclopentadienide.

An “abstractable ligand” is a ligand that can be abstracted from the metal center by a cocatalyst leaving behind an activated catalyst. For purposes of this disclosure, an “abstractable ligand” does not contain sulfur atoms; i.e. all abstractable ligands are non-sulfur-containing ligands.

For purposes of this disclosure oligomers have about 2-75 mer units.

In some structures throughout this specification, drawing the ligand-metal connection with an arrow, showing that the electrons for the bond originally came from the ligand, sometimes indicates coordination. At other times, drawing a solid line, showing the bond's covalent nature, indicates coordination. One of ordinary skill in the art recognizes that these depictions are interchangeable.

The terms “alkyl” or “alkyl radical” refer to a branched or unbranched, saturated or unsaturated, acyclic hydrocarbyl radical. Suitable alkyl radicals include, for example, methyl, ethyl, n-propyl, i-propyl, 2-propenyl (or allyl), vinyl, n-butyl, t-butyl, i-butyl (or 2-methylpropyl). In particular embodiments, alkyls are C1-200 hydrocarbyls, C1-50 hydrocarbyls, or C1-20 hydrocarbyls.

A mer is defined as a unit of an oligomer or polymer that originally corresponded to the monomer that was used in the polymerization reaction. For example, the mer of polyethylene would be ethylene.

Description

Representative metallocene compounds for use with invention catalysts can have the formula:

L_{A} L_{B} L_{Ci} MDE

where M is a Group-3-10 metal; L_{A} is a substituted or unsubstituted, cyclopentadienyl or heterocyclopentadienyl ligand connected to M; and L_{B} is a ligand as defined for L_{A}, or is J, a heteroatom ligand connected to M. L_{A} and L_{B} may connect to each other through a Group-13-to-16-element-containing bridge. L_{Ci} is an optional, neutral, non-oxidizing ligand connected to M (i equals 0 to 3); and D and E are the same or different labile ligands, optionally bridged to each other, L_{A}, or L_{B}. Each of D and E are connected to M. Some embodiments select M to be a member of the Group-3-6 transition metals. Other embodiments select M to be a Group-4 transition metal. Some embodiments select M to be Ti, Zr, or Hf.

D and E's identity is functionally constrained. The first constraint is that upon activation, either the D-M or the E-M connection must break. D and E should be chosen to facilitate this. Another constraint is that a polymerizable molecule must be able to insert between M and whichever of D or E remains.

Cyclopentadienyl and heterocyclopentadienyl ligands encompass fused-ring systems including but not limited to indenyl and fluorenyl radicals. Also, the use of heteroatom-containing rings or fused rings, where a non-carbon, Group-13, -14, -15, or -16 atom replaces a ring carbon is within the term “cyclopentadienyl” for this specification. See, for example, the background and illustrations of WO 98/37106, having priority with U.S. Ser. No. 08/999,214, filed Dec. 29, 1997, and WO 98/41530, having priority with U.S. Ser. No. 09/042,378, filed Mar. 13, 1998. Substituted cyclopentadienyl structures are structures in which one or more hydrogen atoms are replaced by a hydrocarbyl, hydrocarbylsilyl, or similar heteroatom-containing structure. Hydrocarbyl structures specifically include C1-C30 linear, branched, and cyclic alkyl, and aromatic fused and pendant rings. These rings may also be substituted with ring structures. (Throughout this disclosure, cyclopentadienyl and heterocyclopentadienyl ligands are sometimes depicted as

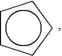

i.e. the ligand is not necessarily drawn to indicate heteroatoms within the ring, to indicate rings fused on to

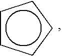

or to indicate side groups or other substitutions on

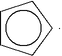

Although the drawing does not necessarily indicate these things, for purposes of this disclosure, a picture with

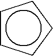

encompasses the full range of C5, aromatic-ring-containing ligands, as described above.)

Catalyst precursors also include the mono- and biscyclopentadienyl compounds such as those listed and described in U.S. Pat. Nos. 5,017,714, 5,324,800, WO 92/00333 and EP-A-0 591 756.

The inventive metallocene complexes with the formula of L2MX2 are synthesized following the schemes set out below. In some embodiments M is Ti, Zr, or Hf. L is a substituted C5-ring-containing ligand such as cyclopentadienyl with an optional bridging group to connect both L ligands. The identity of each L is independent of the other L's identity. The olefinic substituent can be on the C5-ring-containing ligand or on the bridging group. X is a halogen. These metallocene complexes can copolymerize with an olefin such as styrene in the presence of a free-radical initiator (e.g., AIBN). This yields a polymerized olefin polymerization or oligomerization catalyst. Divinyl benzene is optionally added for cross-linking.

Before polymerization into the polystyrene particle, the transition metal catalyst precursors are sometimes simply called catalyst precursors. After polymerization, the catalyst precursors are sometimes called polymerized catalyst precursors. After activation, the polymerized catalyst precursors are sometimes called polymerized catalysts.

In the presence of or after contact with an activator, these enchained transition metal complexes (catalyst precursors) function as ethylene polymerization or oligomerization catalysts. As shown in the Example section, aryl substituents other than the olefinic substituent sometimes affect catalyst performance.

Inventive transition metal complexes are useful to prepare catalysts for olefin polymerization or oligomerization.

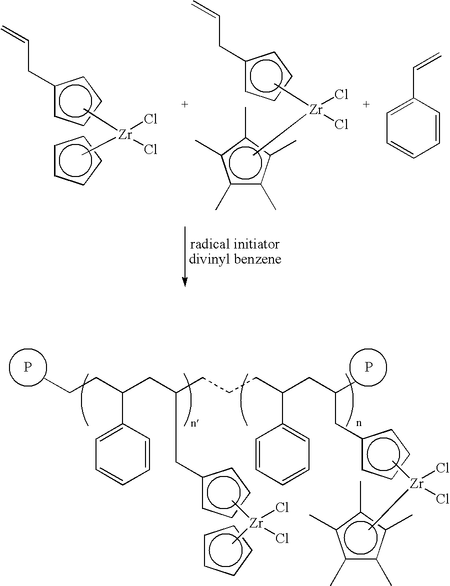

The above picture represents a schematic formula of the polymerized catalyst after polymerization. The P-labeled circles represent the bulk polyolefin/catalyst polymer.

The following examples illustrate the synthetic methods used to prepare these novel metallocene complexes.

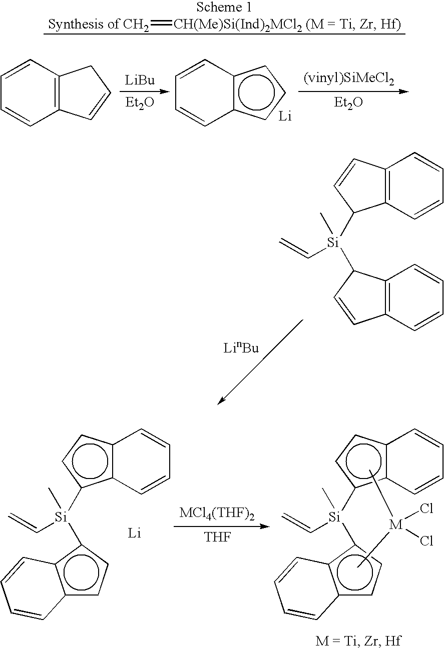

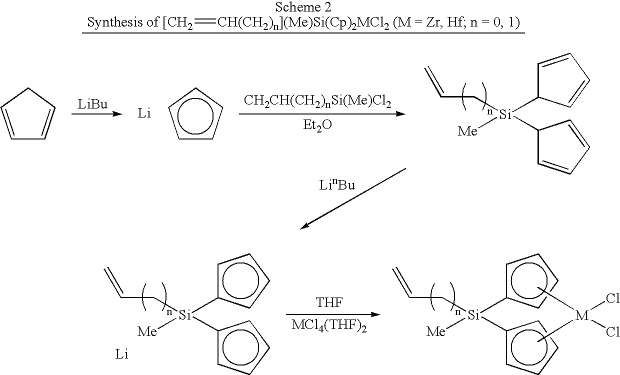

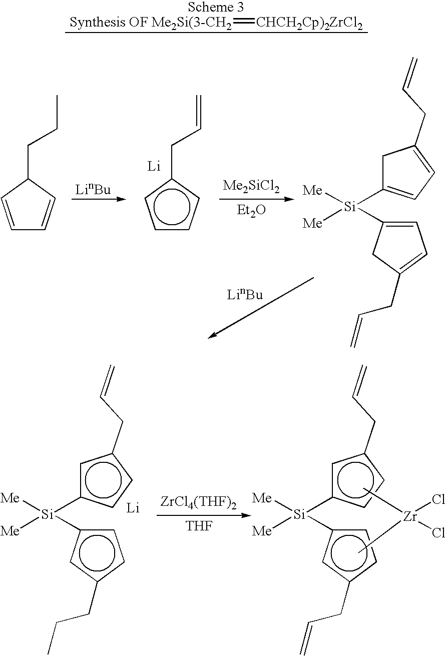

The inventive metallocene complexes can be used to prepare catalysts for olefin polymerization in solution, slurry and gas phase processes.

Catalyst Compounds

The following compounds contain ancillary ligands that themselves contain cyclopentadienyl ligands as described above. These compounds are suitable for use as catalyst precursors when their ancillary ligands have been modified by adding an olefinic substitution, if this addition transforms the compound into a free-radical-polymerizable compound. The compounds are listed by the common names they had before the olefinic substitution. Pentamethylcyclopentadienyltitanium isopropoxide; pentamethylcyclopentadienyltribenzyl titanium; dimethylsilyltetramethyl-cyclopentadienyl-t-butylamido titanium dichloride; pentamethylcyclopentadienyl titanium trimethyl; dimethylsilyltetramethylcyclopentadienyl-t-butylamido zirconium dimethyl; dimethylsilyltetramethylcyclopentadienyl-dodecylamido hafnium dihydride; dimethylsilyltetramethylcyclopentadienyl-dodecylamido hafnium dimethyl; unbridged biscyclopentadienyl compounds such as bis(1-methyl; 3-butylcyclopentadienyl)zirconium dimethyl; (pentamethylcyclopentadienylcyclopentadienyl)zirconium dimethyl; (tetramethylcyclopentadienyl)(n-propylcyclopentadienyl)zirconium dimethyl; bridged bis-cyclopentadienyl; dimethylsilylbis(tetrahydroindenyl)zirconium dichloride; silacyclobutyl(tetramethylcyclopentadienyl)(n-propyl-cyclopentadienyl)zirconium dimethyl; dimethylsilyl (bisindenyl)zirconium dichloride; dimethylsily(bis-indenyl)hafnium dimethyl; dimethylsilylbis(2-methylbenzindenyl)zirconium dichloride; dimethylsilylbis(2-methylbenzindenyl)zirconium dimethyl; and fluorenyl-ligand-containing compounds; e.g.; diphenylmethyl(fluorenyl)(cyclopentadienyl)zirconium dimethyl; tetrabenzyl zirconium; tetrabis(trimethyl-silylmethyl)zirconium; oxotris(trimethisilylmethyl)vanadium; tetrabenzyl hafnium; tetrabenzyl titanium; bis(hexamethyldisilazido)dimethyltitanium; tris(trimethylsilylmethyl)niobium dichloride; tris(trimethylsilylmethyl)tantalum dichloride; (benzylcyclopentadienyl)(cyclopentadienyl)hafnium dihydride; (benzylcyclopentadienyl)(cyclopentadienyl)hafnium dimethyl; (benzylcyclopentadienyl)(cyclopentadienyl)titanium dihydride; (benzylcyclopentadienyl)(cyclopentadienyl)titanium dimethyl; (benzylcyclopentadienyl)(cyclopentadienyl)zirconium dihydride; (benzylcyclopentadienyl)(cyclopentadienyl)zirconium dimethyl.

The following compounds also contain ancillary ligands that themselves contain cyclopentadienyl ligands as described above. These compounds are suitable for use as catalyst precursors when their ancillary ligands have been modified by adding an olefinic substitution, if this addition transforms the compound into a free-radical-polymerizable compound. The compounds are listed by the common names they had before the olefinic substitution. (cyclohexylmethylcyclopentadienyl)(cyclopentadienyl)hafnium dimethyl; (cyclohexylmethylcyclopentadienyl)(cyclopentadienyl)titanium dimethyl; (cyclohexylmethylcyclopentadienyl)(cyclopentadienyl)zirconium dimethyl; (cyclohexylmethylcyclopentadienyl)(cyclopentadienyl)hafnium dihydride; (cyclohexylmethylcyclopentadienyl)(cyclopentadienyl)titanium dihydride; (cyclohexylmethylcyclopentadienyl)(cyclopentadienyl)zirconium dihydride; (dimethylcyclopentadienyl)(cyclopentadienyl)hafnium dihydride; (dimethylcyclopentadienyl)(cyclopentadienyl)hafnium dimethyl; (dimethylcyclopentadienyl)(cyclopentadienyl)titanium dihydride; (dimethylcyclopentadienyl)(cyclopentadienyl)titanium dimethyl; (dimethylcyclopentadienyl)(cyclopentadienyl)zirconium dihydride; (dimethylcyclopentadienyl)(cyclopentadienyl)zirconium dimethyl; (diphenylmethylcyclopentadienyl)(cyclopentadienyl)hafnium dimethyl; (diphenylmethylcyclopentadienyl)(cyclopentadienyl)titanium dimethyl; (diphenylmethylcyclopentadienyl)(cyclopentadienyl)zirconium dimethyl; (diphenylmethylcyclopentadienyl)(cyclopentadienyl)hafnium dihydride; (diphenylmethylcyclopentadienyl)(cyclopentadienyl)titanium dihydride; (diphenylmethylcyclopentadienyl)(cyclopentadienyl)zirconium dihydride; (ethylcyclopentadienyl)(cyclopentadienyl)hafnium dimethyl; (ethylcyclopentadienyl)(cyclopentadienyl)titanium dimethyl; (ethylcyclopentadienyl)(cyclopentadienyl)zirconium dimethyl; (ethylcyclopentadienyl)(cyclopentadienyl)hafnium dihydride; (ethylcyclopentadienyl)(cyclopentadienyl)titanium dihydride; (ethylcyclopentadienyl)(cyclopentadienyl)zirconium dihydride; (ethyltetramethylcyclopentadienyl)(cyclopentadienyl)hafnium dihydride; (ethyltetramethylcyclopentadienyl)(cyclopentadienyl)hafnium dimethyl; (ethyltetramethylcyclopentadienyl)(cyclopentadienyl)titanium dihydride; (ethyltetramethylcyclopentadienyl)(cyclopentadienyl)titanium dimethyl.

The following compounds also contain ancillary ligands that themselves contain cyclopentadienyl ligands as described above. These compounds are suitable for use as catalyst precursors when their ancillary ligands have been modified by adding an olefinic substitution, if this addition transforms the compound into a free-radical-polymerizable compound. The compounds are listed by the common names they had before the olefinic substitution. (ethyltetramethylcyclopentadienyl)(cyclopentadienyl)zirconium dihydride; (ethyltetramethylcyclopentadienyl)(cyclopentadienyl)zirconium dimethyl; (indenyl)(cyclopentadienyl)hafnium dihydride; (indenyl)(cyclopentadienyl)hafnium dimethyl; (indenyl)(cyclopentadienyl)titanium dihydride; (indenyl)(cyclopentadienyl)titanium dimethyl; (indenyl)(cyclopentadienyl)zirconium dihydride; (indenyl)(cyclopentadienyl)zirconium dimethyl; (methylcyclopentadienyl)(cyclopentadienyl)hafnium dihydride; (methylcyclopentadienyl)(cyclopentadienyl)hafnium dimethyl; (methylcyclopentadienyl)(cyclopentadienyl)titanium dihydride; (methylcyclopentadienyl)(cyclopentadienyl)titanium dimethyl; (methylcyclopentadienyl)(cyclopentadienyl)zirconium dihydride; (methylcyclopentadienyl)(cyclopentadienyl)zirconium dimethyl; (n-butylcyclopentadienyl)(cyclopentadienyl)hafnium dimethyl; (n-butylcyclopentadienyl)(cyclopentadienyl)titanium dimethyl; (n-butylcyclopentadienyl)(cyclopentadienyl)zirconium dimethyl; (n-butylcyclopentadienyl)(cyclopentadienyl)hafnium dihydride; (n-butylcyclopentadienyl)(cyclopentadienyl)titanium dihydride; (n-butylcyclopentadienyl)(cyclopentadienyl)zirconium dihydride; (pentamethylcyclopentadienyl)(cyclopentadienyl)hafnium dihydride; (pentamethylcyclopentadienyl)(cyclopentadienyl)hafnium dimethyl; (pentamethylcyclopentadienyl)(cyclopentadienyl)titanium dihydride; (pentamethylcyclopentadienyl)(cyclopentadienyl)titanium dimethyl; (pentamethylcyclopentadienyl)(cyclopentadienyl)zirconium dihydride; (pentamethylcyclopentadienyl)(cyclopentadienyl)zirconium dimethyl; (propylcyclopentadienyl)(cyclopentadienyl)hafnium dimethyl; (propylcyclopentadienyl)(cyclopentadienyl)titanium dimethyl; (propylcyclopentadienyl)(cyclopentadienyl)zirconium dimethyl; (propylcyclopentadienyl)(cyclopentadienyl)hafnium dihydride; (propylcyclopentadienyl)(cyclopentadienyl)titanium dihydride; (propylcyclopentadienyl)(cyclopentadienyl)zirconium dihydride; (t-butylcyclopentadienyl)(cyclopentadienyl)hafnium dimethyl; (t-butylcyclopentadienyl)(cyclopentadienyl)titanium dimethyl; (t-butylcyclopentadienyl)(cyclopentadienyl)zirconium dimethyl.

The following compounds also contain ancillary ligands that themselves contain cyclopentadienyl ligands as described above. These compounds are suitable for use as catalyst precursors when their ancillary ligands have been modified by adding an olefinic substitution, if this addition transforms the compound into a free-radical-polymerizable compound. The compounds are listed by the common names they had before the olefinic substitution. (t-butylcyclopentadienyl)(cyclopentadienyl)hafnium dihydride; (t-butylcyclopentadienyl)(cyclopentadienyl)titanium dihydride; (t-butylcyclopentadienyl)(cyclopentadienyl)zirconium dihydride; (tetramethylcyclopentadienyl)(cyclopentadienyl)hafnium dihydride; (tetramethylcyclopentadienyl)(cyclopentadienyl)hafnium dimethyl; (tetramethylcyclopentadienyl)(cyclopentadienyl)titanium dihydride; (tetramethylcyclopentadienyl)(cyclopentadienyl)titanium dimethyl; (tetramethylcyclopentadienyl)(cyclopentadienyl)zirconium dihydride; (tetramethylcyclopentadienyl)(cyclopentadienyl)zirconium dimethyl; (trifluoromethylcyclopentadienyl)(cyclopentadienyl)hafnium dihydride; (trifluoromethylcyclopentadienyl)(cyclopentadienyl)titanium dihydride; (trifluoromethylcyclopentadienyl)(cyclopentadienyl)zirconium dihydride; (trifluoromethylcyclopentadienyl)(cyclopentadienyl)hafnium dimethyl; (trifluoromethylcyclopentadienyl)(cyclopentadienyl)titanium dimethyl; (trifluoromethylcyclopentadienyl)(cyclopentadienyl)zirconium dimethyl; (trimethylcyclopentadienyl)(cyclopentadienyl)hafnium dihydride; (trimethylcyclopentadienyl)(cyclopentadienyl)hafnium dimethyl; (trimethylcyclopentadienyl)(cyclopentadienyl)titanium dihydride; (trimethylcyclopentadienyl)(cyclopentadienyl)titanium dimethyl; (trimethylcyclopentadienyl)(cyclopentadienyl)zirconium dihydride; (trimethylcyclopentadienyl)(cyclopentadienyl)zirconium dimethyl; (trimethylgermylcyclopentadienyl)(cyclopentadienyl)hafnium dihydride; (trimethylgermylcyclopentadienyl)(cyclopentadienyl)titanium dihydride; (trimethylgermylcyclopentadienyl)(cyclopentadienyl)zirconium dihydride; (trimethylgermylcyclopentadienyl)(cyclopentadienyl)hafnium dimethyl; (trimethylgermylcyclopentadienyl)(cyclopentadienyl)titanium dimethyl; (trimethylgermylcyclopentadienyl)(cyclopentadienyl)zirconium dimethyl; (trimethylplumbylcyclopentadienyl)(cyclopentadienyl)hafnium dihydride; (trimethylplumbylcyclopentadienyl)(cyclopentadienyl)titanium dihydride; (trimethylplumbylcyclopentadienyl)(cyclopentadienyl)zirconium dihydride.

The following compounds also contain ancillary ligands that themselves contain cyclopentadienyl ligands as described above. These compounds are suitable for use as catalyst precursors when their ancillary ligands have been modified by adding an olefinic substitution, if this addition transforms the compound into a free-radical-polymerizable compound. The compounds are listed by the common names they had before the olefinic substitution. (trimethylplumbylcyclopentadienyl)(cyclopentadienyl)hafnium dimethyl; (trimethylplumbylcyclopentadienyl)(cyclopentadienyl)titanium dimethyl; (trimethylplumbyl cyclopentadienyl)(cyclopentadienyl)zirconium dimethyl; (trimethylsilylcyclopentadienyl)(cyclopentadienyl)hafnium dihydride; (trimethylsilylcyclopentadienyl)(cyclopentadienyl)hafnium dimethyl; (trimethylsilylcyclopentadienyl)(cyclopentadienyl)titanium dihydride; (trimethylsilylcyclopentadienyl)(cyclopentadienyl)titanium dimethyl; (trimethylsilylcyclopentadienyl)(cyclopentadienyl)zirconium dihydride; (trimethylsilylcyclopentadienyl)(cyclopentadienyl)zirconium dimethyl; (trimethylstannylcyclopentadienyl)(cyclopentadienyl)hafnium dihydride; (trimethylstannylcyclopentadienyl)(cyclopentadienyl)titanium dihydride; (trimethylstannylcyclopentadienyl)(cyclopentadienyl)zirconium dihydride; [1,1′-(1,1,2,2-tetramethyidisilanylene)bis(3-methylcyclopentadienyl)] zirconium dimethyl; [1,1′-(1,1,2,2-tetramethyldisilanylene)bis(3-trimethylsilanylcyclopentadienyl)] zirconium dimethyl; [1,1′-(1,1,2,2-tetramethyldisilanylene)-bis(4,5,6,7-tetrahydroindenyl)] hafnium dimethyl; [1,1′-(1,1,2,2-tetramethyldisilanylene)-bis(4,5,6,7-tetrahydroindenyl)] titanium dimethyl; [1,1′-(1,1,2,2-tetramethyldisilanylene)-bis(4,5,6,7-tetrahydroindenyl)] zirconium dimethyl; [1,1′-(1,1,3,3-tetramethyldisiloxanylene)bis(4,5,6,7-tetrahydroindenyl)] hafnium dimethyl; [1,1′-(1,1,3,3-tetramethyldisiloxanylene)bis(4,5,6,7-tetrahydroindenyl)] titanium dimethyl; [1,1′-(1,1,3,3-tetramethyldisiloxanylene)bis(4,5,6,7-tetrahydroindenyl)] zirconium dimethyl; [1,1′-(1,1,4,4-tetramethyl-1,4-disilanylbutylene)bis(4,5,6,7-tetrahydroindenyl)] hafnium dimethyl; [1,1′-(1,1,4,4-tetramethyl-1,4-disilanylbutylene)bis(4,5,6,7-tetrahydroindenyl)] titanium dimethyl; [1,1′-(1,1,4,4-tetramethyl-1,4-disilanylbutylene)bis(4,5,6,7-tetrahydroindenyl)] zirconium dimethyl; [1,1′-(2,2-dimethyl-2-silapropylene)-bis(3-methylcyclopentadienyl)] hafnium dimethyl; [1,1′-(2,2-dimethyl-2-silapropylene)-bis(3-methylcyclopentadienyl)] titanium dimethyl; [1,1′-(2,2-dimethyl-2-silapropylene)-bis(3-methylcyclopentadienyl)] zirconium dimethyl; [1,1′-dimethylsilanylenebis(3-methylcyclopentadienyl)] hafnium dimethyl; [1,1′-dimethylsilanylenebis(3-methylcyclopentadienyl)] titanium dimethyl; [1,1′-dimethylsilanylenebis(3-methylcyclopentadienyl)] zirconium dimethyl; [1,1′-dimethylsilanylenebis(3-trimethylsilanylcyclopentadienyl)] hafnium dimethyl; [1,1′-dimethylsilanylene-bis(3-trimethylsilanylcyclopentadienyl)] titanium dimethyl; [1,1′-dimethylsilanylene-bis(3-trimethylsilanylcyclopentadienyl)] zirconium dimethyl; [1,1′-dimethylsilanylene-bis(4,5,6,7-tetrahydroindenyl)] hafnium dimethyl; [1,1′-dimethylsilanylene-bis(4,5,6,7-tetrahydroindenyl)] titanium dimethyl; [1,1′-dimethylsilanylene-bis(4,5,6,7-tetrahydroindenyl)] zirconium dimethyl; [1,1′-dimethylsilanylene-bis(indenyl)] hafnium dimethyl; [1,1′-dimethylsilanylene-bis(indenyl)] titanium dimethyl; [1,1′-dimethylsilanylene-bis(indenyl)] zirconium dimethyl; bis(benzylcyclopentadienyl)hafnium dihydride; bis(benzylcyclopentadienyl)hafnium dimethyl; bis(benzylcyclopentadienyl)titanium dihydride; bis(benzylcyclopentadienyl)titanium dimethyl; bis(benzylcyclopentadienyl)zirconium dihydride; bis(benzylcyclopentadienyl)zirconium dimethyl; bis(cyclohexylmethylcyclopentadienyl)hafnium dihydride; bis(cyclohexylmethylcyclopentadienyl)hafnium dimethyl; bis(cyclohexylmethylcyclopentadienyl)titanium dihydride; bis(cyclohexylmethylcyclopentadienyl)titanium dimethyl; bis(cyclohexylmethylcyclopentadienyl)zirconium dihydride; bis(cyclohexylmethylcyclopentadienyl)zirconium dimethyl; bis(cyclopentadienyl)(trimethylsilyl)(methyl)hafnium; bis(cyclopentadienyl)(trimethylsilyl)(methyl)titanium; bis(cyclopentadienyl)(trimethylsilyl)(methyl)zirconium.

The following compounds also contain ancillary ligands that themselves contain cyclopentadienyl ligands as described above. These compounds are suitable for use as catalyst precursors when their ancillary ligands have been modified by adding an olefinic substitution, if this addition transforms the compound into a free-radical-polymerizable compound. The compounds are listed by the common names they had before the olefinic substitution. Bis(cyclopentadienyl)[tris(dimethylsilyl)silyl](methyl)hafnium; bis(cyclopentadienyl)[tris(dimethylsilyl)silyl](methyl)titanium; bis(cyclopentadienyl)[tris(dimethylsilyl)silyl](methyl)zirconium; bis(cyclopentadienyl)(trimethylsilyl)(tris(trimethylsilyl)(trimethylsilylbenzyl); bis(cyclopentadienyl)(triphenylsilyl)(methyl)hafnium; bis(cyclopentadienyl)(triphenylsilyl)(methyl)titanium; bis(cyclopentadienyl)(triphenylsilyl)(methyl)zirconium; bis(cyclopentadienyl)hafnium di(m-tolyl); bis(cyclopentadienyl)hafnium di(p-tolyl); bis(cyclopentadienyl)hafnium dibutyl; bis(cyclopentadienyl)hafnium diethyl; bis(cyclopentadienyl)hafnium dihydride; bis(cyclopentadienyl)hafnium dimethyl; bis(cyclopentadienyl)hafnium dineopentyl; bis(cyclopentadienyl)hafnium diphenyl; bis(cyclopentadienyl)hafnium dipropyl; bis(cyclopentadienyl)titanium di(m-tolyl); bis(cyclopentadienyl)titanium di(p-tolyl); bis(cyclopentadienyl)titanium dibutyl; bis(cyclopentadienyl)titanium diethyl; bis(cyclopentadienyl)titanium dihydride; bis(cyclopentadienyl)titanium dimethyl; bis(cyclopentadienyl)titanium dineopentyl; bis(cyclopentadienyl)titanium diphenyl; bis(cyclopentadienyl)titanium dipropyl; bis(cyclopentadienyl)zirconium di(m-tolyl); bis(cyclopentadienyl)zirconium di(p-tolyl); bis(cyclopentadienyl)zirconium dibutyl; bis(cyclopentadienyl)zirconium diethyl; bis(cyclopentadienyl)zirconium dihydride; bis(cyclopentadienyl)zirconium dimethyl; bis(cyclopentadienyl)zirconium dineopentyl; bis(cyclopentadienyl)zirconium diphenyl; bis(cyclopentadienyl)zirconium dipropyl; bis(dimethylcyclopentadienyl)hafnium dihydride; bis(dimethylcyclopentadienyl)hafnium dimethyl; bis(dimethylcyclopentadienyl)titanium dihydride; bis(dimethylcyclopentadienyl)titanium dimethyl; bis(dimethylcyclopentadienyl)zirconium dihydride; bis(dimethylcyclopentadienyl)zirconium dimethyl; bis(diphenylmethylcyclopentadienyl)hafnium dihydride; bis(diphenylmethylcyclopentadienyl)hafnium dimethyl; bis(diphenylmethylcyclopentadienyl)titanium dihydride; bis(diphenylmethylcyclopentadienyl)titanium dimethyl; bis(diphenylmethylcyclopentadienyl)zirconium dihydride; bis(diphenylmethylcyclopentadienyl)zirconium dimethyl; bis(ethylcyclopentadienyl)hafnium dimethyl; bis(ethylcyclopentadienyl)titanium dimethyl; bis(ethylcyclopentadienyl)zirconium dimethyl; bis(ethyltetramethylcyclopentadienyl)hafnium dimethyl; bis(ethyltetramethylcyclopentadienyl)titanium dimethyl; bis(ethyltetramethylcyclopentadienyl)zirconium dimethyl; bis(ethyltetramethylcyclopentadienyl)hafnium dihydride; bis(ethyltetramethylcyclopentadienyl)titanium dihydride; bis(ethyltetramethylcyclopentadienyl)zirconium dihydride; bis(indenyl)hafnium dihydride; bis(indenyl)hafnium dimethyl; bis(indenyl)titanium dihydride; bis(indenyl)titanium dimethyl; bis(indenyl)zirconium dihydride; bis(indenyl)zirconium dimethyl; bis(methylcyclopentadienyl)hafnium dimethyl; bis(methylcyclopentadienyl)titanium dimethyl; bis(methylcyclopentadienyl)zirconium dimethyl; bis(methylcyclopentadienyl)hafnium dihydride; bis(methylcyclopentadienyl)titanium dihydride.

The following compounds also contain ancillary ligands that themselves contain cyclopentadienyl ligands as described above. These compounds are suitable for use as catalyst precursors when their ancillary ligands have been modified by adding an olefinic substitution, if this addition transforms the compound into a free-radical-polymerizable compound. The compounds are listed by the common names they had before the olefinic substitution. Bis(methylcyclopentadienyl)zirconium dihydride; bis(n-butylcyclopentadienyl)hafnium dimethyl; bis(n-butylcyclopentadienyl)titanium dimethyl; bis(n-butylcyclopentadienyl)zirconium dimethyl; bis(n-butylcyclopentadienyl)hafnium dihydride; bis(n-butylcyclopentadienyl)titanium dihydride; bis(n-butylcyclopentadienyl)zirconium dihydride; bis(pentamethylcyclopentadienyl)(benzyne)hafnium; bis(pentamethylcyclopentadienyl)(benzyne)titanium; bis(pentamethylcyclopentadienyl)(benzyne)zirconium; bis(pentamethylcyclopentadienyl)hafnium dimethyl; bis(pentamethylcyclopentadienyl)titanium dimethyl; bis(pentamethylcyclopentadienyl)zirconacyclopentane; bis(pentamethylcyclopentadienyl)zirconium dimethyl; bis(pentamethylcyclopentadienyl)hafnium (methyl)(hydride); bis(pentamethylcyclopentadienyl)hafnium (phenyl)(hydride); bis(pentamethylcyclopentadienyl)hafnium dihydride; bis(pentamethylcyclopentadienyl)titanium (methyl)(hydride); bis(pentamethylcyclopentadienyl)titanium (phenyl)(hydride); bis(pentamethylcyclopentadienyl)titanium dihydride; bis(pentamethylcyclopentadienyl)zirconacyclobutane; bis(pentamethylcyclopentadienyl)zirconium (methyl)(hydride); bis(pentamethylcyclopentadienyl)zirconium (phenyl)(hydride); bis(pentamethylcyclopentadienyl)zirconium dihydride; bis(propylcyclopentadienyl)hafnium dimethyl; bis(propylcyclopentadienyl)titanium dimethyl; bis(propylcyclopentadienyl)zirconium dimethyl; bis(propylcyclopentadienyl)hafnium dihydride; bis(propylcyclopentadienyl)titanium dihydride; bis(propylcyclopentadienyl)zirconium dihydride; bis(t-butylcyclopentadienyl)hafnium dimethyl; bis(t-butylcyclopentadienyl)titanium dimethyl; bis(t-butylcyclopentadienyl)zirconium dimethyl; bis(t-butylcyclopentadienyl)hafnium dihydride; bis(t-butylcyclopentadienyl)titanium dihydride; bis(t-butylcyclopentadienyl)zirconium dihydride; bis(tetramethylcyclopentadienyl)hafnium dihydride; bis(tetramethylcyclopentadienyl)hafnium dimethyl; bis(tetramethylcyclopentadienyl)titanium dihydride; bis(tetramethylcyclopentadienyl)titanium dimethyl.

The following compounds also contain ancillary ligands that themselves contain cyclopentadienyl ligands as described above. These compounds are suitable for use as catalyst precursors when their ancillary ligands have been modified by adding an olefinic substitution, if this addition transforms the compound into a free-radical-polymerizable compound. The compounds are listed by the common names they had before the olefinic substitution. Bis(tetramethylcyclopentadienyl)zirconium dihydride; bis(tetramethylcyclopentadienyl)zirconium dimethyl; bis(trifluoromethylcyclopentadienyl)hafnium dihydride; bis(trifluoromethylcyclopentadienyl)hafnium dimethyl; bis(trifluoromethylcyclopentadienyl)titanium dihydride; bis(trifluoromethylcyclopentadienyl)titanium dimethyl; bis(trifluoromethylcyclopentadienyl)zirconium dihydride; bis(trifluoromethylcyclopentadienyl)zirconium dimethyl; bis(trimethylcyclopentadienyl)hafnium dihydride; bis(trimethylcyclopentadienyl)hafnium dimethyl; bis(trimethylcyclopentadienyl)titanium dihydride; bis(trimethylcyclopentadienyl)titanium dimethyl; bis(trimethylcyclopentadienyl)zirconium dihydride; bis(trimethylcyclopentadienyl)zirconium dimethyl; bis(trimethylgermylcyclopentadienyl)hafnium dihydride; bis(trimethylgermylcyclopentadienyl)hafnium dimethyl; bis(trimethylgermylcyclopentadienyl)titanium dihydride; bis(trimethylgermylcyclopentadienyl)titanium dimethyl; bis(trimethylgermylcyclopentadienyl)zirconium dihydride; bis(trimethylgermylcyclopentadienyl)zirconium dimethyl; bis(trimethylplumbylcyclopentadienyl)hafnium dihydride; bis(trimethylplumbylcyclopentadienyl)hafnium dimethyl; bis(trimethylplumbylcyclopentadienyl)titanium dihydride; bis(trimethylplumbylcyclopentadienyl)titanium dimethyl; bis(trimethylplumbylcyclopentadienyl)zirconium dihydride; bis(trimethylplumbylcyclopentadienyl)zirconium dimethyl; bis(trimethylsilylcyclopentadienyl)hafnium dihydride; bis(trimethylsilylcyclopentadienyl)hafnium dimethyl; bis(trimethylsilylcyclopentadienyl)titanium dihydride; bis(trimethylsilylcyclopentadienyl)titanium dimethyl; bis(trimethylsilylcyclopentadienyl)zirconium dihydride; bis(trimethylsilylcyclopentadienyl)zirconium dimethyl; bis(trimethylstannylcyclopentadienyl)hafnium dihydride; bis(trimethylstannylcyclopentadienyl)titanium dihydride; bis(trimethylstannylcyclopentadienyl)zirconium dihydride; dibutylsilyl (fluorenyl)(cyclopentadienyl)hafnium dimethyl; diethylsilanediylbis-(2-methylindenyl)-zirconium diethyl; diethylsilanediylbis-(2-methylindenyl)zirconium dimethyl; dimethylsilanediylbis-(2-ethyl-5-isopropylcyclopentadienyl)-zirconium dimethyl; dimethylsilanediylbis-(2-ethylindenyl)zirconium dimethyl; dimethylsilanediylbis-(2-isopropylindenyl)-zirconium dimethyl; dimethylsilanediylbis-(2-methyl-5-ethylcyclopentadienyl)zirconium dimethyl.

The following compounds also contain ancillary ligands that themselves contain cyclopentadienyl ligands as described above. These compounds are suitable for use as catalyst precursors when the ancillary ligands have been modified by adding an olefinic substitution, if this addition transforms the compound into a free-radical-polymerizable compound. The compounds are listed by the common names they had before the olefinic substitution. Dimethylsilanediylbis-(2-methyl-5-methylcyclopentadienyl)-zirconium dimethyl; dimethylsilanediylbis-(2-methylbenzindenyl)-zirconium dimethyl; dimethylsilanediylbis-(2-methylindanyl)-zirconium dimethyl; dimethylsilanediylbis-(2-methylindenyl)-hafnium dimethyl; dimethylsilanediylbis-(2-methylindenyl)-zirconium dimethyl; dimethylsilanediylbis-(2-t-butylindenyl)-zirconium dimethyl; dimethylsilyl (indenyl)(fluorenyl)hafnium dihydride; dimethylsilyl bis(2-methyl-indenyl)hafnium dimethyl; dimethylsilyl bis(2-propyl-indenyl)hafnium dimethyl; dimethylsilyl bis(4-methyl, 2-phenyl-indenyl)hafnium dimethyl; dimethylsilyl bis(cyclopentadienyl)hafnium dihydride; dimethylsilyl bis(cyclopentadienyl)titanium dihydride; dimethylsilyl bis(cyclopentadienyl)zirconium dihydride; dimethylsilyl bis(indenyl)hafnium dimethyl; dimethylsilyl(methylcyclopentadienyl)(1-fluorenyl)hafnium dihydride; dimethylsilyl(methylcyclopentadienyl)(1-fluorenyl)titanium dihydride; dimethylsilyl(methylcyclopentadienyl)(1-fluorenyl)zirconium dihydride; dimethylsilylbis(3-trimethylsilylcyclopentadienyl)hafnium dihydride; dimethylsilylbis(3-trimethylsilylcyclopentadienyl)titanium dihydride; dimethylsilylbis(3-trimethylsilylcyclopentadienyl)zirconium dihydride; dimethylsilylbis(indenyl)hafnium dimethyl; dimethylsilylbis(indenyl)titanium dimethyl; dimethylsilylbis(indenyl)zirconium dimethyl; dimethylthiobis-(2-methylindenyl)-zirconium dimethyl; dinapthylmethylene (cyclopentadienyl)(fluorenyl)hafnium dimethyl; diphenylmethylene (2,7-di-n-butyl fluorenyl)(cyclopentadienyl)hafnium dimethyl; diphenylmethylene (2,7-di-n-butyl fluorenyl)(fluorenyl)hafnium dimethyl; diphenylmethylene (2,7-di-t-butyl fluorenyl)(cyclopentadienyl)hafnium dimethyl; diphenylmethylene (2,7-di-t-butyl fluorenyl)(fluorenyl)hafnium dimethyl; diphenylmethylene (2,7-di-t-butyl-5-methylfluorenyl)(cyclopentadienyl)hafnium dimethyl; diphenylmethylene (cyclopentadienyl)(2,7-dimethylfluorenyl)hafnium dimethyl; diphenylmethylene (cyclopentadienyl)(2,7-di-t-butyl fluorenyl)hafnium dimethyl; diphenylmethylene (indenyl)(2,7-di-t-butyl fluorenyl)hafnium dibenzyl; ethylene bis(cyclopentadienyl)hafnium dihydride; ethylene bis(cyclopentadienyl)hafnium dihydride; dimethylsilyl bis(cyclopentadienyl)hafnium dihydride; ethylene bis(cyclopentadienyl)hafnium dimethyl; ethylene bis(cyclopentadienyl)titanium dihydride.

The following compounds also contain ancillary ligands that themselves contain cyclopentadienyl ligands as described above. These compounds are suitable for use as catalyst precursors when their ancillary ligands have been modified by adding an olefinic substitution, if this addition transforms the compound into a free-radical-polymerizable compound. The compounds are listed by the common names they had before the olefinic substitution. Ethylene bis(cyclopentadienyl)titanium dihydride; dimethylsilyl bis(cyclopentadienyl)titanium dihydride; ethylene bis(cyclopentadienyl)titanium dimethyl; ethylene bis(cyclopentadienyl)zirconium dihydride; ethylene bis(cyclopentadienyl)zirconium dihydride; ethylene bis(cyclopentadienyl)zirconium dimethyl; ethylenebis(indenyl)hafnium dimethyl; ethylenebis(indenyl)titanium dimethyl; ethylenebis(indenyl)zirconium dimethyl; ethylenebis(tetrahydroindenyl)hafnium dimethyl; ethylenebis(tetrahydroindenyl)titanium dimethyl; ethylenebis(tetrahydroindenyl)zirconium dimethyl; i-propyl (cyclopentadienyl)(fluorenyl)hafnium dimethyl; isopropyl(cyclopentadienyl)(1-fluorenyl)hafnium dimethyl; isopropyl(cyclopentadienyl)(1-fluorenyl)titanium dimethyl; isopropyl(cyclopentadienyl)(1-fluorenyl)zirconium dimethyl; isopropyl(cyclopentadienyl)(1-octahydro-fluorenyl)hafnium dimethyl; isopropyl(cyclopentadienyl)(1-octahydro-fluorenyl)titanium dimethyl; isopropyl(cyclopentadienyl)(1-octahydro-fluorenyl)zirconium dimethyl; methylene (2,7-di-t-butyl fluorenyl)(fluorenyl)hafnium dimethyl; methylene (indenyl)(2,7-di-t-butyl-fluorenyl)hafnium dimethyl; methylene bis(cyclopentadienyl)hafnium dimethyl; methylene bis(cyclopentadienyl)titanium dimethyl; methylene bis(cyclopentadienyl)zirconium dimethyl; methylene bis(fluorenyl)hafnium dimethyl; methylene(cyclopentadienyl (tetramethylcyclopentadienyl)hafnium dimethyl; methylene(cyclopentadienyl (tetramethylcyclopentadienyl)titanium dimethyl; methylene(cyclopentadienyl (tetramethylcyclopentadienyl)zirconium dimethyl; methylene(cyclopentadienyl)(1-fluorenyl)hafnium dihydride; methylene(cyclopentadienyl)(1-fluorenyl)titanium dihydride; methylene(cyclopentadienyl)(1-fluorenyl)zirconium dihydride; methylphenylmethylene bis(fluorenyl)hafnium dimethyl; bis(methylcyclopentadienyl)zirconium dimethyl; bis(ethylcyclopentadienyl)zirconium dimethyl; bis(methylcyclopentadienyl)zirconium dimethyl; bis(ethylcyclopentadienyl)zirconium dimethyl; bis(methylcyclopentadienyl)zirconium dihydride; bis(ethylcyclopentadienyl)zirconium dihydride; bis(dimethylcyclopentadienyl)zirconium dimethyl; bis(trimethylcyclopentadienyl)zirconium dimethyl; bis(tetramethylcyclopentadienyl)zirconium dimethyl; bis(ethyltetramethylcyclopentadienyl)zirconium dimethyl; bis(indenyl)zirconium dimethyl.

The following compounds also contain ancillary ligands that themselves contain cyclopentadienyl ligands as described above. These compounds are suitable for use as catalyst precursors when their ancillary ligands have been modified by adding an olefinic substitution, if this addition transforms the compound into a free-radical-polymerizable compound. The compounds are listed by the common names they had before the olefinic substitution. Bis(dimethylcyclopentadienyl)zirconium dimethyl; bis(trimethylcyclopentadienyl)zirconium dimethyl; bis(tetramethylcyclopentadienyl)zirconium dimethyl; bis(ethyltetramethylcyclopentadienyl)zirconium dimethyl; bis(indenyl)zirconium dimethyl; bis(dimethylcyclopentadienyl)zirconium dihydride; bis(trimethylcyclopentadienyl)zirconium dihydride; bis(ethyltetramethylcyclopentadienyl)zirconium dihydride; bis(trimethylsilylcyclopentadienyl)zirconium dimethyl; bis(trimethylsilylcyclopentadienyl)zirconium dihydride; bis(trifluoromethylcyclopentadienyl)zirconium dimethyl; bis(trifluoromethylcyclopentadienyl)zirconium dimethyl; bis(trifluoromethylcyclopentadienyl)zirconium dihydride; isopropylidene-bis(indenyl)zirconium dimethyl; isopropylidene-bis(indenyl)zirconium dimethyl; isopropylidene-bis(indenyl)zirconium dihydride; pentamethylcyclopentadienyl(cyclopentadienyl)zirconium dimethyl; pentamethylcyclopentadienyl(cyclopentadienyl)zirconium dimethyl; pentamethylcyclopentadienyl(cyclopentadienyl)zirconium dihydride; ethyltetramethylcyclopentadienyl(cyclopentadienyl)zirconium dihydride; isopropylidene(cyclopentadienyl)(fluorenyl)zirconium dimethyl; isopropylidene(cyclopentadienyl)(fluorenyl)zirconium dimethyl; dimethylsilyl(cyclopentadienyl)(fluorenyl)zirconium dimethyl; isopropylidene(cyclopentadienyl)(fluorenyl)zirconium dihydride, bis(cyclopentadienyl)zirconium dimethyl; bis(cyclopentadienyl)zirconium dimethyl; bis(cyclopentadienyl)zirconium diethyl; bis(cyclopentadienyl)zirconium dipropyl; bis(cyclopentadienyl)zirconium diphenyl; methylcyclopentadienyl(cyclopentadienyl)zirconium dimethyl; ethylcyclopentadienyl(cyclopentadienyl)zirconium dimethyl; methylcyclopentadienyl(cyclopentadienyl)zirconium dimethyl; ethylcyclopentadienyl(cyclopentadienyl)zirconium dimethyl; methylcyclopentadienyl(cyclopentadienyl)zirconium dihydride; ethylcyclopentadienyl(cyclopentadienyl)zirconium dihydride; dimethylcyclopentadienyl(cyclopentadienyl)zirconium dimethyl; trimethylcyclopentadienyl(cyclopentadienyl)zirconium dimethyl; tetramethylcyclopentadienyl(cyclopentadienyl)zirconium dimethyl; bis(pentamethylcyclopentadienyl)zirconium dimethyl; tetramethylcyclopentadienyl(cyclopentadienyl)zirconium dimethyl; indenyl(cyclopentadienyl)zirconium dimethyl; dimethylcyclopentadienyl(cyclopentadienyl)zirconium dimethyl; trimethylcyclopentadienyl(cyclopentadienyl)zirconium dimethyl; tetramethylcyclopentadienyl(cyclopentadienyl)zirconium dimethyl; bis(pentamethylcyclopentadienyl)zirconium dimethyl.

The following compounds also contain ancillary ligands that themselves contain cyclopentadienyl ligands as described above. These compounds are suitable for use as catalyst precursors when their ancillary ligands have been modified by adding an olefinic substitution, if this addition transforms the compound into a free-radical-polymerizable compound. The compounds are listed by the common names they had before the olefinic substitution. Ethyltetramethylcyclopentadienyl(cyclopentadienyl)zirconium dimethyl; indenyl(cyclopentadienyl)zirconium dimethyl; dimethylcyclopentadienyl(cyclopentadienyl)zirconium dihydride; trimethylcyclopentadienyl(cyclopentadienyl)zirconium dihydride; bis(pentamethylcyclopentadienyl)zirconium dihydride; indenyl(cyclopentadienyl)zirconium dihydride; trimethylsilylcyclopentadienyl(cyclopentadienyl)zirconium dimethyl; trimethylsilylcyclopentadienyl(cyclopentadienyl)zirconium dihydride; trifluoromethylcyclopentadienyl(cyclopentadienyl)zirconium dimethyl; trifluoromethylcyclopentadienyl(cyclopentadienyl)zirconium dimethyl; trifluoromethylcyclopentadienyl(cyclopentadienyl)zirconium dihydride; bis(cyclopentadienyl)(trimethylsilyl)(methyl)zirconium; bis(cyclopentadienyl)(triphenylsilyl)(methyl)zirconium; bis(cyclopentadienyl)[tris(dimethylsilyl)silyl](methyl)zirconium; bis(cyclopentadienyl)[bis(methylsilyl)silyl](methyl)zirconium; bis(cyclopentadienyl)(trimethylsilyl)(trimethylsilyl methyl)zirconium; bis(cyclopentadienyl)(trimethylsilyl)(benzyl)zirconium; methylene-bis(cyclopentadienyl)zirconium dimethyl; ethylene-bis(cyclopentadienyl)zirconium dimethyl; isopropylidene-bis(cyclopentadienyl)zirconium dimethyl; dimethylsilyl-bis(cyclopentadienyl)zirconium dimethyl; methylene-bis(cyclopentadienyl)zirconium dimethyl; ethylene-bis(cyclopentadienyl)zirconium dimethyl; isopropylidene-bis(cyclopentadienyl)zirconium dimethyl; dimethylsilyl-bis(cyclopentadienyl)zirconium dimethyl; methylene-bis(cyclopentadienyl)zirconium dihydride; ethylene-bis(cyclopentadienyl)zirconium dihydride; isopropylidene-bis(cyclopentadienyl)zirconium dihydride; dimethylsilyl-bis(cyclopentadienyl)zirconium dihydride; (pentamethylcyclopentadienyl)zirconium trimethyl; (pentamethylcyclopentadienyl)zirconium triphenyl; (pentamethylcyclopentadienyl)zirconium tribenzyl; (pentamethylcyclopentadienyl)zirconium trimethyl; (cyclopentadienyl)zirconium trimethyl; (cyclopentadienyl)zirconium triphenyl; (cyclopentadienyl)zirconium tribenzyl; (cyclopentadienyl)zirconium trimethyl; (methylcyclopentadienyl)zirconium trimethyl; (methylcyclopentadienyl)zirconium triphenyl; (methylcyclopentadienyl)zirconium tribenzyl; (methylcyclopentadienyl)zirconium trimethyl; (dimethylcyclopentadienyl)zirconium trimethyl; (trimethylcyclopentadienyl)zirconium trimethyl; (trimethylsilylcyclopentadienyl)zirconium trimethyl; (tetramethylcyclopentadienyl)zirconium trimethyl; indenylzirconium trimethyl; fluorenylzirconium trimethyl; bis(cyclopentadienyl)zirconium dimethyl; bis(cyclopentadienyl)zirconium diphenyl; bis(cyclopentadienyl)zirconium dibenzyl; bis(cyclopentadienyl)zirconium dimethyl; bis(cyclopentadienyl)zirconium diethyl; bis(cyclopentadienyl)zirconium dihydride; bis(cyclopentadienyl)zirconium dichlorohydride; bis(methylcyclopentadienyl)zirconium dimethyl; bis(methylcyclopentadienyl)zirconium diphenyl; bis(methylcyclopentadienyl)zirconium dibenzyl; bis(methylcyclopentadienyl)zirconium dimethyl; bis(pentamethylcyclopentadienyl)zirconium dimethyl; bis(pentamethylcyclopentadienyl)zirconium dimethyl; bis(pentamethylcyclopentadienyl)zirconium dibenzyl; bis(pentamethylcyclopentadienyl)zirconium methylmethyl; bis(pentamethylcyclopentadienyl)zirconium methylhydride; ethylenebis(indenyl)zirconium dimethyl; ethylenebis(indenyl)zirconium dimethyl; ethylenebis(tetrahydroindenyl)zirconium dimethyl; ethylenebis(tetrahydroindenyl)zirconium dimethyl; dimethylsilylenebis(cyclopentadienyl)zirconium dimethyl; dimethylsilylenebis(cyclopentadienyl)zirconium dimethyl; isopropylidene(cyclopentadienyl)(9-fluorenyl)zirconium dimethyl; phenylmethylmethylene(cyclopentadienyl)(9-fluorenyl)zirconium dimethyl; diphenylmethylene(cyclopentadienyl)(9-fluorenyl)zirconium dimethyl; ethylene(cyclopentadienyl)(9-fluorenyl)zirconium dimethyl; cyclohyxylidene(cyclopentadienyl)(9-fluorenyl)zirconium dimethyl; cyclopentylidene(cyclopentadienyl)(9-fluorenyl)zirconium dimethyl; cyclobutylidene(cyclopentadienyl)(9-fluorenyl)zirconium dimethyl; dimethylsilylene(cyclopentadienyl)(9-fluorenyl)zirconium dimethyl; dimethylsilylenebis(2,3,5-trimethylcyclopentadienyl)zirconium dimethyl; dimethylsilylenebis(2,3,5-trimethylcyclopentadienyl)zirconium dimethyl; dimethylsilylenebis(indenyl)zirconium dimethyl; zirconium tetramethyl; zirconium tetrabenzyl; zirconium tetramethyl; zirconium tetramethyl; zirconium butoxytrimethyl; zirconium dibutoxydimethyl.

The following compounds also contain ancillary ligands that themselves contain cyclopentadienyl ligands as described above. These compounds are suitable for use as catalyst precursors when their ancillary ligands have been modified by adding an olefinic substitution, if this addition transforms the compound into a free-radical-polymerizable compound. The compounds are listed by the common names they had before the olefinic substitution. Bis(2,5-di-t-butylphenoxy)zirconium dimethyl; Bis(2,5-di-t-butylphenoxy)zirconium dimethyl; Zirconium bis(acetylacetonate)dimethyl; dimethylsilyl(tetramethylclopentadienyl)cycldodecyloamido)titanium dimethyl; dimethylsilyl(tetra-methyleyclopentadienyl)(1-adamantylamido)titanium dimethyl; dimethylsilyl(tetramethylcyclopentadienyl)(t-butylamido)titanium dimethyl; cyclopentadienylzirconium trimethyl; cyclopentadienylzirconium triethyl; cyclopentadienylzirconium tripropyl; cyclopentadienyltitanium trimethyl; cyclopentadienyltitanium triphenyl; cyclopentadienylscandium bis(p-tolyl); cyclopentadienylchromium 2,4-pentadienyl; (pentamethylcyclopentadienyl)yttrium bis(bistrimethylsilylmethyl); (pentamethylcyclopentadienyl)scandium bis(bistrimethylsilylmethyl); pentamethylcyclopentadienyl lanthanum bis(bistrimethyl-silylmethyl); [1,1′-dimethylsilanylene-bis(2-methyl-indenyl)] hafnium dimethyl; [1,1′-dimethylsilanylene-bis(2-methy-4-phenyl-lindenyl)] hafnium dimethyl; [1,1′-dimethylsilanylene-bis(2-methy-4-naphth-2-yl-lindenyl)] hafnium dimethyl; diphenylmethylene (cyclopentadienyl)(fluorenyl)hafnium dimethyl; [(4-n-butylphenyl)(4-t-butylphenyl)methylene] (cyclopentadienyl)(fluorenyl)hafnium dimethyl; dimethylsilanylene (tetramethylcyclopentadienyl)(N-adamantylamido)titanium dimethyl; dimethylsilanylene (tetramethylcyclopentadienyl)(N-t-butylamido)titanium dimethyl; bis(4-[triethylsilyl])methylene (cyclopentadienyl)(fluorenyl)hafnium dimethyl; bis(4-[triethylsilyl])methylene (cyclopentadienyl)(2,7-di-t-butylfluorenyl)hafnium dimethyl.

Process to Prepare the Polymerized Catalyst Compounds

The catalyst precursor described above is then contacted with a free radical initiator and one or more monomers that can be polymerized by a free radical initiator. The catalyst compound containing the terminal unsaturation, as described above, is contacted with a free radical initiator and one or more, free-radical-polymerizable monomers.

A typical metallocene metal catalyst is polymerized using the following procedure. 50 ml of a toluene solution with the terminal-unsaturation-containing catalyst, styrene, and AIBN was kept at 80° C. for 7 hrs. The resulting solution was evaporated and residue was washed with dried mixture solution of hexane and toluene (2:1). The solid polymer product was collected. An analogous method was used for preparation of other polymerized catalysts.

The polymerization typically takes place in solution at a temperature of 30-100° C., 50-90° C., 70-85° C., or 75-85° C. Suitable solvents include toluene, benzene, xylene, and hexane. Desired solvents are selected from those that can dissolve the terminal unsaturation-containing catalyst.

The polymerization may be performed at atmospheric, sub-atmospheric or super-atmospheric pressures.

Generally, the structure of a catalyst will look like this before copolymerization.

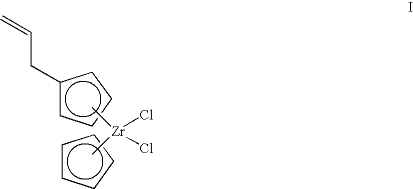

Generally, the structure of a copolymer of a catalyst and an olefin looks like this.

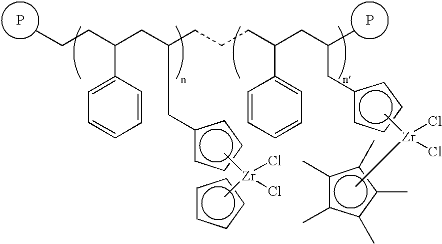

The polymerized catalyst compounds typically have Mw of up to 300,000; 500-150,000; 1,000-100,000; 5,000-75,000; or 10,000-50,000.

Free Radical Initiators

Free radical initiators that are useful in this invention include: (1) thermally decomposable compounds which generate radicals such as azo compounds or organic peroxides; (2) compounds which generate free radicals by non-thermal methods such as photochemical or redox processes; (3) compounds which have inherent radical character such as molecular oxygen; or (4) electromagnetic radiation such as X-rays, electron beams, visible light and ultraviolet-light. Suitable organic peroxide compounds include hydroperoxides, dialkyl peroxides, diacyl peroxides, peroxyesters, peroxydicarbonates, peroxyketals, ketone peroxides and organosulfonyl peroxides. Especially preferred peroxides are t-butyl perbenzoate, dicumyl peroxide, 2,5-dimethyl-2,5-di-tert-butylperoxy-3-hexyne (Lupersol 130), alpha,alpha.-bis(tert-butylperoxy)diisopropyl benzene (VulCup R).

Any free radical initiator or mixture having a 10-hour half-life temperature over 80° C. or their mixtures may function as the initiator in invention processes to prepare supported polymerized catalyst compounds. Generally, the higher the decomposition temperature of the peroxygen compound, the better. See pages 66-67 of Modern Plastics, November 1971 for a more complete list of such compounds.

In one embodiment, the free radical initiator is an organic peroxide compound having a half-life, at the reaction temperature, of less than one tenth of the reaction/residence time employed. The free radical initiator is used at concentrations of 1-5% weight percent based on styrene.

The following classes and examples of free-radical initiators are useful in polymerizing invention, terminal-unsaturation-containing, catalyst precursors:

| | | |
|---|---|---|
| Azo initiators | Dialkyldiazenes | 2,2′-azobis(2- |
| | | methylpropanenitrile) |
| | | (AIBN) |
| | | 1,1-azobis(1- |
| | | cyclohexanenitrile) |
| | | 4,4′-azobis(4-cyanovaleric |
| | | acid) |
| | | riphenylmethylazobenzene |
| | Hyponitrites | di-t-butyl hyponitrite |
| | | Dicumyl hyponitrite |
| Peroxides | diacyl peroxides | Dibenzoyl peroxide |
| | | Didodecanoyl peroxide |
| | | Diacetyl peroxide |
| | dialkyl peroxydicarbonates | Diisopropyl ester |
| | | Dicyclohexyl ester |
| | Peresters | |
| | alkyl hydroperoxides | Cumyl hydroperoxide |
| | | t-butyl hydroperoxide |
| | dialkyl peroxides | Dicumyl peroxide |
| | | di-t-butyl peroxide |
| | inorganic peroxides | Hydrogen peroxide |
| | | persulfate |

Monomers Polymerizable by a Free Radical Initiator

Monomers that can be polymerized by a free radical process include ethylene, 1,3-butadiene, isoprene, styrene, alkyl styrene, isobutylene, vinyl chloride, vinylidene chloride, vinyl fluoride, tetrafluoroethylene, vinyl esters, acrylic esters, methacrylic esters, acrylonitrile, and propylene. Therefore, any of these can be copolymerized with the catalyst compound containing the terminal unsaturation. For example, selecting isoprene for copolymerization results in a catalyst/isoprene copolymer.

Process to Polymerize Olefins Using the Polymerized Catalyst Compound

Combining the polymerized catalyst compounds described above with one or more activators forms an olefin-polymerization catalyst system.

For purposes of this disclosure, the terms activator and cocatalyst are used interchangeably. An activator functions to remove an abstractable ligand X from the transition metal. After activation the transition metal is left with an empty coordination site at which incoming α-olefin can coordinate before it is incorporated into the oligomer or polymer. Any reagent that can so function without destroying the commercial viability of the oligomerization or polymerization process is suitable for use as an activator or cocatalyst in this invention.

Invention-suitable activators include Lewis acid, non-coordinating ionic activators or ionizing activators, or any other compound including Lewis bases, aluminum alkyls, conventional-type cocatalysts, and their combinations that can convert a catalyst compound into a catalytically active cation. This invention can use alumoxane or modified alumoxane as an activator, and can also use ionizing activators, neutral or ionic, such as tri (n-butyl) ammonium tetrakis(pentafluorophenyl) boron, a trisperfluorophenyl boron metalloid precursor or a trisperfluoronaphthyl boron metalloid precursor, polyhalogenated heteroborane anions (WO 98/43983), or their combinations. This invention can use these compounds as activators if they can ionize the catalyst metal compound or if the catalyst metal compound can be pre-reacted to form a compound that these activators can ionize.

One class of invention-suitable activators includes alumoxanes such as methylalumoxane, modified methylalumoxane, ethylalumoxane, etc.; aluminum alkyls such as trimethyl aluminum, triethyl aluminum, triisopropyl aluminum, etc.; alkyl aluminum halides such as diethyl aluminum chloride, etc.; and alkylaluminum alkoxides.

An alumoxane component useful as an activator is typically an oligomeric aluminum compound represented by the general formula (R″—Al—O)n, which is a cyclic compound, or R″(R″—Al—O)nAlR″2, which is a linear compound. Generally, R″ is independently a C1-C20 alkyl radical, for example, methyl, ethyl, propyl, butyl, pentyl, isomers thereof, etc., and “n” is an integer from 1-50. Those of ordinary skill in the art recognize that alumoxanes in which R″ is methyl and “n” is at least four are particularly useful: methylalumoxane and modified methylalumoxanes. For further descriptions see, EP 279586, EP 561476, WO94/10180, and U.S. Pat. Nos. 4,665,208, 4,908,463, 4,924,018, 4,952,540, 4,968,827, 5,041,584, 5,103,031, 5,157,137, 5,235,081, 5,248,801, 5,329,032, 5,391,793, and 5,416,229.

Those of ordinary skill in the art know how to prepare alumoxanes and modified alumoxanes. See U.S. Pat. Nos. 4,665,208, 4,952,540, 5,091,352, 5,206,199, 5,204,419, 4,874,734, 4,924,018, 4,908,463, 4,968,827, 5,308,815, 5,329,032, 5,248,801, 5,235,081, 5,157,137, 5,103,031, 5,391,793, 5,391,529, 5,693,838, 5,731,253, 5,731,451, 5,744,656, 5,847,177, 5,854,166, 5,856,256 and 5,939,346 and European publications EP-A-0 561 476, EP-B1-0 279 586, EP-A-0 594-218 and EP-B1-0 586 665, and PCT publication WO 94/10180.

Another class of invention-suitable activators includes aluminum alkyl components represented by the general formula R″AlZ2 where R″ is defined above for alumoxanes, and each Z is independently R″ or a different univalent anionic ligand such as halogen (Cl, Br, I), alkoxide (OR″), etc. Particularly useful aluminum alkyls include triethylaluminum, diethylaluminum chloride, triisobutylaluminum, tri-n-octylaluminum, etc.

When alumoxane or aluminum alkyl activators are used, the catalyst-precursor-to-activator molar ratio is from about 1:1000 to 10:1; alternatively, 1:500 to 1:1; or 1:300 to 1:10.

Yet another class of invention-suitable activators includes discrete ionic activators. These are especially useful when both abstractable ligands are hydride or hydrocarbyl. [Me2PhNH][B(C6F5)4], [Bu3NH][BF4], [NH4][PF6], [NH4][SbF6], [NH4][AsF6], [NH4][B(C6H5)4] or Lewis acidic activators such as B(C6F5)3 or B(C6H5)3 are examples of discrete ionic activators. Discrete ionic activators provide for an activated catalyst site and a relatively non-coordinating (or weakly coordinating) anion. Activators of this type are well known, see for instance W. Beck, et al., Chem. Rev., vol. 88, p. 1405-1421 (1988); S. H. Strauss, Chem. Rev., vol. 93, p. 927-942 (1993); U.S. Pat. Nos. 5,198,401; 5,278,119; 5,387,568; 5,763,549; 5,807,939; 6,262,202; and WO93/14132; WO99/45042; WO01/30785; and WO01/42249. These activator types also function when X is not hydrocarbyl, if they are used with a compound capable of alkylating the metal such as an alumoxane or aluminum alkyl.

When a discrete ionic activator is used, the catalyst-precursor-to-activator molar ratio is from 10:1 to 1:10; 5:1 to 1:5; 2:1 to 1:2; or 1.2:1 to 1:1.

Another class of invention-suitable activators includes those described in PCT publication WO 98/07515 such as tris(2,2′,2″-nonafluorobiphenyl) fluoroaluminate. Combining activators from different classes suits this invention, for example, alumoxanes and ionizing activators in combinations, see for example, EP-B1 0 573 120, PCT publications WO 94/07928 and WO 95/14044 and U.S. Pat. Nos. 5,153,157 and 5,453,410. WO 98/09996 describes activating catalyst compounds with perchlorates, periodates, and iodates including their hydrates. WO 98/30602 and WO 98/30603 describe the use of lithium (2,2′-bisphenyl-ditrimethylsilicate).4THF as an activator for a catalyst compound. WO 99/18135 describes the use of organo-boron-aluminum activators. EP-B1-0 781 299 describes using a silylium salt in combination with a non-coordinating compatible anion. Also, activation methods using irradiation (see EP-B1-0 615 981), electrochemical oxidation, etc., are also useful for activating catalyst precursors. Other activators or activating methods are described in, for example, U.S. Pat. Nos. 5,849,852, 5,859,653 and 5,869,723 and WO 98/32775, WO 99/42467 (dioctadecylmethylammonium-bis(tris(pentafluorophenyl)borane) benzimidazolide).

Combining modified alumoxanes with invention polymerized catalyst compounds forms a catalyst system. MMAO3A (modified methyl alumoxane in heptane, commercially available from Akzo Chemicals, Inc., Holland, under the trade name Modified Methylalumoxane type 3A) is such an example. Combining the alumoxanes disclosed in U.S. Pat. No. 5,041,584 with invention polymerized catalyst compounds forms a catalyst system, as well.

Polymerization Processes (TM Catalyzed)

Some of the catalyst systems described above are suitable for use in solution polymerization processes, some for use in gas-phase processes, and some in slurry processes. Some of the catalyst systems above are suitable for use in combinations of those processes.

In invention polymerization or oligomerization processes using invention catalyst systems, the process temperature can be −100° C. to 300° C., −20° C. to 200° C., or 0° C. to 150° C. Given one of these temperature ranges, the following ethylene polymerization or oligomerization pressures (gauge) are useful: 0 kPa-35 MPa or 500 kPa-15 MPa.

In polymerization or oligomerization processes using invention catalyst systems and any of the process conditions described above, whether the selected process is solution, slurry, gas-phase or an amalgamation of these, the process can employ one or more, C2-C30 monomers. Alternatively, C2-C12 or C2-C8 monomers are suitable. Specific examples of invention-suitable monomers include one or more of ethylene, propylene, butene-1, pentene-1, 4-methyl-pentene-1, hexene-1, octene-1, decene-1, 3-methyl-pentene-1, and cyclic olefins, or their combinations. Other monomers can include vinyl monomers, diolefins such as dienes, polyenes, norbornene, norbornadiene, vinyl norbornene, ethylidene norbornene monomers. Alternatively, invention polymerization processes produce homopolymers or copolymers of ethylene or propylene.

In polymerization or oligomerization processes using invention catalyst systems and any of the process conditions described above, polymerization with ethylene and at least two different comonomers forms terpolymers. Invention comonomers comprise a combination of any of the monomers described above or of C2-C30 or C4-C8, α-olefin monomers, optionally with at least one diene monomer. Terpolymers include combinations such as propylene/but-1-ene/hex-1-ene, propylene/but-1-ene/ethylene, propylene/ethylene/hex-1ene, propylene/butene/norbornene, propylene/butene/decadiene, and the like. For purposes of this disclosure, nomenclature such as “but-1-ene”, which indicates that the olefinic unsaturation in the butene molecule begins at the first atom in the butene carbon chain, is equivalent to “butene-1”.

Invention oligomerization or polymerization processes can be run in the presence of various liquids, particularly aprotic organic liquids. In some embodiments the catalyst system is insoluble in most solvents; and thus, the polymerization will be slurry phase rather than solution phase. Liquid-suitable invention catalyst systems include alkanes, alkenes, cycloalkanes, selected halogenated hydrocarbons, aromatic hydrocarbons, and in some cases, hydrofluorocarbons. Useful solvents specifically include hexane, toluene, cyclohexane, and benzene.

Gas-phase Polymerization

In polymerization or oligomerization processes using invention catalyst systems, the reactor pressure in a gas-phase process can vary from 69 kPa-3.5 MPa, alternatively from 690 kPa-3.5 MPa, from 1379 kPa-2.8 MPa, or from 1.7-2.414 MPa. Invention processes and catalyst systems can use suitable gas-phase polymerization processes; some of these processes are described below.

In gas-phase, polymerization or oligomerization processes using invention catalyst systems, given a particular reactor pressure range, the reactor temperature can vary from 30-120° C., alternatively from 60-115° C., from 70-110° C., or from 70-95° C. The reactor temperature is typically between 70-105° C. for high-density polyethylene.

In gas-phase systems, polymerization or oligomerization processes using invention catalyst systems, monomer partial pressure influences catalyst system productivity. Primary monomer concentration, such as ethylene or propylene, is from 25-90 mole percent, and its partial pressure is from 138-517 kPa or 517 kPa-2.1 MPa. These conditions suit invention gas-phase, polymerization or oligomerization processes. Also, in some systems, comonomer presence yields productivity increases.

Gas-phase, polymerization or oligomerization processes using invention catalyst systems can produce 227-90,900 kg/hr of polymer, alternatively, 227-455 kg/hr, 227-4540 kg/hr, 227-11,300 kg/hr, 227-15,900 kg/hr, 227-22,700 kg/hr, and alternatively 29,000 kg/hr-45,500 kg/hr, or 45,500 kg/hr or more.

Gas-phase, polymerization or oligomerization processes using invention catalyst systems can use the processes described in U.S. Pat. Nos. 5,627,242, 5,665,818 and 5,677,375, and European publications EP-A-0 794 200, EP-A-0 802 202 and EP-B-634 421.

In some gas-phase, polymerization or oligomerization processes using invention catalyst systems, the reactor receives the liquid or solution catalyst system in its liquid form at a resin-particle-lean zone. For information on how to introduce a liquid catalyst system into a fluidized bed polymerization reactor at a resin-particle-lean zone, see U.S. Pat. No. 5,693,727.

Gas-phase, polymerization or oligomerization processes using invention catalyst systems can operate with scavengers. Typical scavengers include trimethyl aluminum, tri-isobutyl aluminum, an excess of alumoxane or modified alumoxane, triethylaluminum, tri-n-hexylaluminum, diethyl aluminum chloride, dibutyl zinc and the like. PCT publication WO 96/08520 and U.S. Pat. No. 5,712,352 describe processes using these scavengers. Invention, gas-phase processes or catalyst systems can use these processes. Alternatively, gas-phase, polymerization, or oligomerization processes using invention catalyst systems can operate in the absence of or essentially free of scavengers.

Slurry Polymerization

In polymerization or oligomerization processes using invention catalyst systems, slurry polymerization processes generally use pressures of 103-5068 kPa and temperatures of 0-120° C. Invention processes and catalyst systems can use suitable slurry polymerization processes; some of these processes are described below.

Typically, in a slurry polymerization, a suspension of solid, particulate polymer forms in a liquid polymerization medium to which ethylene (or α-olefinic monomer) and comonomers, along with catalyst, has been added. This suspension intermittently or continuously discharges from the reactor, after which the process separates the polymer from the volatile components and recycles them (optionally after a distillation) to the reactor. The liquid employed in the polymerization medium typically comprises a C3-C7 alkane, alternatively a branched alkane. The medium should be liquid and relatively inert under the polymerization conditions. For propane media, process temperatures and pressures are usually above the media's critical temperature and pressure. The processes can use hexane or isobutane media, as well.

One slurry polymerization process is a particle-form polymerization. It is a process where the temperature remains below the temperature at which the polymer appreciably dissolves in the reaction medium. Such techniques are well known in the art. U.S. Pat. No. 3,248,179. Particle-form process temperatures range from 85° C.-110° C. Two other slurry polymerization varieties employ a loop reactor or a plurality of stirred reactors in series, parallel, or combinations thereof. These reactors can have cooling or not and can employ refrigerated or unrefrigerated monomer feeds. Non-limiting examples of slurry processes include continuous-loop and stirred-tank processes. Also, U.S. Pat. No. 4,613,484 describes other examples of slurry processes.

Slurry processes can use a continuous-loop reactor. The process regularly injects the catalyst, as a slurry in a compatible solvent or as a dry, free-flowing powder, into the reactor loop. The loop contains a circulating slurry of growing polymer particles in a diluent of isobutane containing monomer and comonomer. If desired, this process can control molecular weight with hydrogen. The reactor is maintained at a pressure of 3.620-4.309 MPa and at a temperature of 60-104° C. depending on the desired polymer density. Reaction heat is removed from the reactor through the loop wall since much of the reactor vessel is a double-jacketed pipe. The slurry discharges from the reactor at regular intervals or continuously. It discharges into a heated, low-pressure flash vessel, rotary dryer, and nitrogen purge column, in sequence, to remove isobutane diluent and all unreacted monomer and comonomer. The resulting hydrocarbon-free powder is then compounded for use in various applications.

Polymerization or oligomerization processes using invention catalyst systems and using slurry polymerization conditions can produce 1-100,000 kg polymer/hr, 907-100,000 kg/hr, 2268-100,000 kg/hr, 4540-100,000 kg/hr, 6804-100,000 kg/hr, 11,340-100,000 kg/hr, or 45,500-100,000 kg/hr.

Polymerization or oligomerization processes using invention catalyst systems and using slurry polymerization conditions can use total reactor pressures in the range of 2758-5516 kPa, 3103-4827 kPa, 3448-4482 kPa, or 3620-4309 kPa.

Polymerization or oligomerization processes using invention catalyst systems and using slurry polymerization conditions can use concentrations of predominant monomer in the reactor liquid medium of 1-10 wt %, 2-7 wt %, 2.5-6 wt %, or 3-6 wt %.

As with gas-phase polymerization conditions, polymerization or oligomerization processes using invention catalyst systems and slurry polymerization conditions can use slurry process variants that include or exclude scavengers.

Applications of Invention Polyolefins

Invention processes prepare homo- and co-polymer polyethylene useful for formulating adhesives and other materials.

Formulations.

In some embodiments, the polymer produced by this invention may be blended with one or more other polymers such as thermoplastic polymer(s) and elastomer(s).

A thermoplastic polymer is a polymer that can be melted by heating and then cooled without appreciable change in properties. Thermoplastic polymers typically include polyolefins, polyamides, polyesters, polycarbonates, polysulfones, polyacetals, polylactones, acrylonitrile-butadiene-styrene resins, polyphenylene oxide, polyphenylene sulfide, styrene-acrylonitrile resins, styrene maleic anhydride, polyimides, aromatic polyketones, or mixtures of two or more of the above. Specific polyolefins include polymers comprising one or more, linear, branched, or cyclic, C2-C40 olefins, preferably polymers comprising ethylene or propylene copolymerized with one or more, C3-C40 olefins, C3-C20 α-olefins, or C3-C10 α-olefins.

Elastomers include all natural and synthetic rubbers, including those defined in ASTM D1566. Examples of elastomers include ethylene propylene rubber, ethylene propylene diene monomer rubber, styrenic block copolymer rubbers (including SI, SIS, SB, SBS, SIBS and the like, where S=styrene, I=isobutylene, and B=butadiene), butyl rubber, halobutyl rubber, copolymers of isobutylene and para-alkylstyrene, halogenated copolymers of isobutylene and para-alkylstyrene, natural rubber, polyisoprene, copolymers of butadiene with acrylonitrile, polychloroprene, alkyl acrylate rubber, chlorinated isoprene rubber, acrylonitrile chlorinated isoprene rubber, polybutadiene rubber (both cis and trans).

In another embodiment polymer produced by this invention is combined with one or more isotactic polypropylenes; highly isotactic polypropylenes; syndiotactic polypropylenes; random copolymers of propylene and ethylene or butene or hexene; polybutenes; ethylene vinyl acetate; low-density polyethylenes (density 0.915 to 0.935 g/cm3); linear-low-density polyethylenes; ultra-low-density polyethylenes (density 0.86 to 0.90 g/cm3); very-low-density polyethylenes (density 0.90 to 0.915 g/cm3); medium-density polyethylenes (density 0.935 to 0.945 g/cm3); high-density polyethylenes (density 0.945 to 0.98 g/cm3); ethylene vinyl acetates; ethylene methyl acrylates; copolymers of acrylic acid, polymethylmethacrylate, or any other polymers polymerizable by high-pressure free radical processes; polyvinylchlorides, polybut-l-enes; isotactic polybutenes; ABS resins; ethylene-propylene rubbers (EPR); vulcanized EPRs; EPDMs; block copolymers; styrenic block copolymers; polyamides; polycarbonates; PET resins; crosslinked polyethylenes; copolymers of ethylene and vinyl alcohol (EVOH); or polymers of aromatic monomers such as polystyrene; poly-1-esters; polyacetal; polyvinylidine fluoride; polyethylene glycols; or polyisobutylenes.

In another embodiment, elastomers are blended with the polymer produced by this invention to form rubber-toughened compositions. In some embodiments, the rubber toughened composition is a two (or more) phase system where the elastomer is a discontinuous phase and the polymer produced by this invention is a continuous phase. This blend may be combined with tackifiers or other additives as is known in the art.

In another embodiment, the polymer produced by this invention may be blended to form impact copolymers. In some embodiments, the blend is a two (or more) phase system with a discontinuous phase and a continuous phase. This blend may be combined with tackifiers or other additives as is known in the art.

In some embodiments invention polymers are combined with metallocene polyethylenes (mPEs) or metallocene polypropylenes (mPPs). The mPE and mPP homopolymers or copolymers are typically produced using mono- or bis-cyclopentadienyl transition metal catalysts in combination with alumoxane or a non-coordinating anion activator in solution, slurry, high-pressure, or gas-phase conditions. The supported or unsupported catalyst and activator may have substituted or unsubstituted cyclopentadienyl rings. ExxonMobil Chemical Company (Baytown, Tex.) produces several commercial products with such catalyst and activator combinations. These are commercially available under the tradenames EXCEED™, ACHIEVE™, and EXAC™. For more information on the methods and catalyst-activator pairs used to produce such homopolymers and copolymers, see WO 94/26816; WO 94/03506; EPA 277,003; EPA 277,004; U.S. Pat. No. 5,153,157; U.S. Pat. No. 5,198,401; U.S. Pat. No. 5,240,894; U.S. Pat. No. 5,017,714; CA 1,268,753; U.S. Pat. No. 5,324,800; EPA 129,368; U.S. Pat. No. 5,264,405; EPA 520,732; WO 92 00333; U.S. Pat. No. 5,096,867; U.S. Pat. No. 5,507,475; EPA 426 637; EPA 573 403; EPA 520 732; EPA 495 375; EPA 500 944; EPA 570 982; WO91/09882; WO94/03506 and U.S. Pat. No. 5,055,438.

In some embodiments invention polymers are present in the above blends, at from 10-99 wt %, 20-95 wt %, 30-90 wt %, 40-90 wt %, 50-90 wt %, 60-90 wt %, 70-90 wt %. (Based upon the weight of the polymers in the blend.)

The blends described above may be produced by mixing the invention polymers with one or more polymers (as described above), by connecting reactors together in series to make reactor blends, or by using more than one catalyst in the same reactor to produce multiple species of polymer. The polymers can be mixed together before being put into the extruder or may be mixed in the extruder.

Any of the above polymers may be functionalized, which means that the polymer has been reacted with an unsaturated acid or anhydride. Unsaturated acids and anhydrides include any unsaturated organic compound containing at least one double bond and at least one carbonyl group. Representative acids include carboxylic acids, anhydrides, esters and their metallic and non-metallic salts. In some embodiments the organic compound contains an ethylenic unsaturation conjugated with a carbonyl group (—C═O). Examples include maleic, fumaric, acrylic, methacrylic, itaconic, crotonic, alpha.methyl crotonic, and cinematic acids as well as their anhydrides, esters and salt derivatives. The unsaturated acid or anhydride is present at 0.1-10 wt %, 0.5-7 wt % or 1-4 wt %, based upon the weight of the hydrocarbon resin and the unsaturated acid or anhydride.

Tackifiers may be blended with invention polymers or with blends of invention polymers (as described above). Examples of useful tackifiers include aliphatic hydrocarbon resins, aromatic modified aliphatic hydrocarbon resins, hydrogenated polycyclopentadiene resins, polycyclopentadiene resins, gum rosins, gum rosin esters, wood rosins, wood rosin esters, tall oil rosins, tall oil rosin esters, polyterpenes, aromatic modified polyterpenes, terpene phenolics, aromatic modified hydrogenated polycyclopentadiene resins, hydrogenated aliphatic resin, hydrogenated aliphatic aromatic resins, hydrogenated terpenes and modified terpenes, and hydrogenated rosin esters. In some embodiments, the tackifier is hydrogenated. In other embodiments, the tackifier is non-polar. (Non-polar means that the tackifier is substantially free of monomers having polar groups. Some tackifier compositions limit the polar-group content to 5 wt % or less, alternatively, 2 or 0.5 wt % or less.) In some embodiments the tackifier has a softening point (Ring and Ball, as measured by ASTM E-28) of 80-40 or 100-30° C. In some embodiments, the tackifier is functionalized, which means that the hydrocarbon resin has been contacted with an unsaturated acid or anhydride. Some embodiments select unsaturated acids or anhydrides from any unsaturated organic compound containing at least one double bond and at least one carbonyl group. Representative acids include carboxylic acids, anhydrides, esters and their salts, both metallic and non-metallic. In some embodiments the organic compound contains an ethylenic unsaturation conjugated with a carbonyl group (—C═O). Examples include maleic, fumaric, acrylic, methacrylic, itaconic, crotonic, alpha.methyl crotonic, and cinnamic acids as well as their anhydrides, esters and salt derivatives. The unsaturated acid or anhydride is present at 0.1 wt %, alternatively 0.5 wt % or 1 wt %, based upon the weight of the hydrocarbon resin and the unsaturated acid or anhydride.

Invention polymers, or their blends, may further comprise a crosslinking agent. Particularly suitable crosslinking agents include those having functional groups that can react with the acid or anhydride group. Alcohols, multiols, amines, diamines, and triamines belong to a nonexclusive list of crosslinking agents. Examples of useful crosslinking agents include polyamines such as ethylenediamine, diethylenetriamine, hexamethylenediamine, diethylaminopropylamine, and menthanediamine.

Invention polymers, or their blends, may further comprise typical additives known in the art such as fillers, cavitating agents, antioxidants, surfactants, adjuvants, plasticizers, antiblock additives, color masterbatches, pigments, dyes, processing aids, UV stabilizers, neutralizers, lubricants, waxes, or nucleating agents. Typically, these additives are present in amounts well known to be effective in the art: such as 0.001-10 wt %.

Specific fillers, cavitating agents, or nucleating agents include titanium dioxide, calcium carbonate, barium sulfate, silica, silicon dioxide, carbon black, sand, glass beads, mineral aggregates, talc, clay, etc.

Effective antioxidants include phenolic antioxidants, such as Irganox 1010, Irganox, 1076 both available from Ciba-Geigy. Effective oils include paraffinic or naphthenic oils, such as Primol 352 or Primol 876 available from ExxonMobil Chemical France, S.A. (Paris, France) and aliphatic naphthenic oils, white oils, etc.

Effective plasticizers and adjuvants include mineral oils, polybutenes, phthalates, etc. Plasticizers include phthalates such as diisoundecyl phthalate (DIUP), diisononylphthalate (DINP), dioctylphthalates (DOP), and polybutenes.

Effective processing aids, lubricants, waxes, and oils include low molecular weight products such as wax, oil or low Mn polymer, (low meaning Mn below 5000, below 4000, below 3000, or below 2500). Effective waxes include polar or non-polar waxes, functionalized waxes, polypropylene waxes, polyethylene waxes, and wax modifiers. Effective functionalized waxes include those modified with an alcohol, an acid, or a ketone.

Some invention polymers are functionalized after polymerization. Functionalized means that the polymer has been contacted with an unsaturated acid or anhydride. Suitable unsaturated acids or anhydrides include any unsaturated organic compound comprising one double bond and one carbonyl group. Representative acids include carboxylic acids, anhydrides, esters and their salts, both metallic and non-metallic. Some useful organic compound contains an ethylenic unsaturation conjugated with a carbonyl group (—C═O). Examples include maleic, fumaric, acrylic, methacrylic, itaconic, crotonic, alpha.methyl crotonic, and cinnamic acids as well as their anhydrides, esters and salt derivatives. The unsaturated acid or anhydride is present at 0.1-10 wt %, alternatively 0.5-7 wt % or 1-4 wt % based upon the weight of the hydrocarbon resin and the unsaturated acid or anhydride. Specific examples include waxes modified by methyl ketone, maleic anhydride, or maleic acid. Suitable low Mn polymers include lower α-olefins polymers such as propylene, butene, pentene, hexene, etc. Some embodiments select the polymer such that it includes polybutene having an Mn of less than 1000.

### APPLICATIONS

Invention polymers (and their blends as described above) whether formed in situ or by physical blending are used in any known thermoplastic or elastomer application. Examples include uses in molded parts, films, tapes, sheets, tubing, hose, sheeting, wire and cable coating, adhesives, shoe soles, bumpers, gaskets, bellows, films, fibers, elastic fibers, nonwoven materials, spunbond materials, sealants, surgical gowns, and medical devices.

Adhesives

Invention polymers or their blends can be used as adhesives, either alone or combined with tackifiers. Preferred tackifiers are described above. The tackifier is typically present at about 1 wt % to about 50 wt %, based upon the weight of the blend, more preferably 10 wt % to 40 wt %, even more preferably 20 wt % to 40 wt %. Other additives, as described above, may be added also.

Invention-polymer-based adhesives can be used in any adhesive application, such as disposable items, packaging, laminates, pressure-sensitive adhesives, tapes labels, wood binding, paper binding, non-woven materials, road marking materials, reflective coatings, etc. In some embodiments Invention-polymer-based adhesives can be used for chassis construction in disposable diapers and napkins, elastic attachment in disposable-goods, and converting, packaging, labeling, bookbinding, woodworking, and other assembly applications. Specific articles include diaper liquid-transfer layers, diaper leg elastics, diaper frontal tapes, diaper standing-leg cuffs, feminine-napkin adhesive strips and perishable product packaging. Specific applications include laminations for diaper outer covers, diaper elastic cuffs, filter materials, filter masks, surgical gowns, and surgical drapes; core stabilization for diapers and feminine-napkins; diaper chassis construction; and filtration system bonding.

The invention-polymer-based adhesives described above may be applied to any substrate. Useful substrates include wood, paper, cardboard, plastic, thermoplastic, rubber, metal, metal foil (such as aluminum foil and tin foil), metallized surfaces, cloth, non-woven cloth (particularly polypropylene cloths), spunbonded fiber, cardboard, stone, plaster, glass (including silicon oxide (SiOx) coatings applied by evaporating silicon oxide onto a film surface), foam, rock, ceramic, film, polymer foam (such as polyurethane foam), coated substrate (such as those coated with inks, dyes, pigments), polyvinylidene chloride, etc. or their combinations. Additional useful substrates include polyethylene, polypropylene, polyacrylates, acrylics, polyethylene terephthalate, or any of the polymers listed above as suitable for blends. Any of the above substrates may be modified by corona treatment, electron beam irradiation, gamma irradiation, microwave, or silanization.

Films

Invention polymers and their blends can form mono- or multi-layer films. These films may be formed by any of the conventional techniques known in the art including extrusion, co-extrusion, extrusion coating, and lamination, blowing and casting. These films may be formed by the flat film or tubular process; afterwards they may be oriented in a uniaxial or in two mutually perpendicular directions in the film's plane. One or more of the layers of the film may be oriented in the transverse or longitudinal directions to the same or different extents. This orientation may occur before or after bringing the individual layers together. For example, a polyethylene layer can be extrusion coated or laminated onto an oriented polypropylene layer, or the polyethylene and polypropylene can be coextruded into a film, then oriented. Likewise, oriented polypropylene could be laminated to oriented polyethylene or oriented polyethylene could be coated onto polypropylene. Further orientation could follow, if desired. Film orientation in the machine direction (MD) is typically at a ratio of 1-15 or 5-7, while orientation in the transverse direction (TD) is typically at a ratio of 1-15 or 7-9. But in some embodiments, MD and TD orientation ratios are the same.

In another embodiment, the layer comprising the invention polymer compositions (or their blends) may be combined with one or more other layers. The other layer(s) may be any of those layers typically included in multilayer films. For example, the other layer or layers may be polyolefins (such as homopolymers or copolymers of C2-C40 olefins or C2-C20 olefins) or copolymers of α-olefins and other olefins (including α-olefins and ethylene). Specific polyolefins for use as other layers include homopolyethylene; homopolypropylene; propylene copolymerized with ethylene or butene; and ethylene copolymerized with one or more of propylene, butene or hexene, and optional dienes. Specific examples include thermoplastic polymers such as ultra-low-density polyethylene, very-low-density polyethylene, linear-low-density polyethylene, low-density polyethylene, medium-density polyethylene, high-density polyethylene, polypropylene, isotactic polypropylene, highly isotactic polypropylene, syndiotactic polypropylene, random copolymer of propylene and ethylene, butene, hexene, elastomers such as ethylene propylene rubber, ethylene propylene diene monomer rubber, neoprene, and blends of thermoplastic polymers and elastomers, such as for example, thermoplastic elastomers and rubber toughened plastics.

Likewise, the other layer or layers may be polar polymers. Specific polar polymers include homopolymers and copolymers of esters, amides, acetates, anhydrides, copolymers of C2-C20 olefins (such as ethylene and/or propylene and/or butene with one or more polar monomers such as acetates, anhydrides, esters, alcohol, or acrylics). Specific examples include polyesters, polyamides, ethylene-vinyl-acetate copolymers, and polyvinyl chloride.

Likewise, the other layer or layers may be cationic polymers. Specific cationic polymers include polymers or copolymers of geminally disubstituted olefins, α-heteroatom-olefins, or styrenic monomers. Specific geminally disubstituted olefins include isobutylene, isopentene, isoheptene, isohexane, isooctene, isodecene, and isododecene. Specific α-heteroatom-olefins include vinyl ether and vinyl carbazole. Specific styrenic monomers include styrene, alkyl styrene, para-alkyl styrene, α-methyl styrene, chloro-styrene, and bromo-para-methyl styrene. Specific examples of cationic polymers include butyl rubber, isobutylene copolymerized with para methyl styrene, polystyrene, and poly-α-methyl styrene.

Finally, other specific layers can be paper, wood, cardboard, metal, metal foils (such as aluminum foil and tin foil), metallized surfaces, glass (including silicon oxide (SiOx) coatings applied by evaporating silicon oxide onto a film surface), fabric, spunbonded fibers, and non-wovens (particularly polypropylene spun bonded fibers or non-wovens), and substrates coated with inks, dyes, pigments, polyvinylidene chloride and the like.

The films may vary in thickness depending on the intended application; films from 1-250 μm thick are usually suitable. Packaging films are usually from 10-60 μm thick. Sealing layers are typically 0.2-50 μm. There may be a sealing layer on both the inner and outer surfaces of the film or the sealing layer may be present on only the inner or the outer surface. Additives such as antiblock additives, antioxidants, pigments, fillers, processing aids, UV stabilizers, neutralizers, lubricants, surfactants and/or nucleating agents may also be present in one or more layers in the films. Specific additives include silicon dioxide, titanium dioxide, polydimethylsiloxane, talc, dyes, wax, calcium stearate, carbon black, low-molecular-weight resins, and glass beads. In some embodiments one or more layers may be modified by corona treatment, electron beam irradiation, gamma irradiation, or microwave. In some embodiments one or both of the surface layers is modified by corona treatment.

The films described herein may also comprise from 5-60 wt % of a hydrocarbon resin, based upon the weight of the polymer and the resin. The resin may be combined with the polymer of the seal layer(s) or may be combined with the polymer in the core layer(s). The resin softening point is 100-200° C. or 130-180° C. Preferred hydrocarbon resins include those described above. The films comprising a hydrocarbon resin may be oriented in uniaxial or biaxial directions to the same or different degrees.

The films described above may be used as stretch or cling films. Stretch-cling films are used in various bundling, packaging and palletizing operations. A number of well-known tackifying additives impart cling properties to or improve the cling properties of a particular film. Common tackifying additives include polybutenes, terpene resins, alkali metal stearates, and hydrogenated rosins and rosin esters. Corona discharge can also modify film properties. Some polymers (such as ethylene-methylacrylate copolymers) do not need cling additives and can be used as cling layers without tackifiers. Stretch-clings films may comprise a slip layer comprising any suitable polyolefin or combination of polyolefins such as polyethylene, polypropylene, copolymers of ethylene and propylene, and polymers obtained from ethylene or propylene copolymerized with minor amounts of other olefins, particularly C4-C12 olefins. Polypropylene and linear low density polyethylene (LLDPE) work well. Suitable polypropylene is normally solid and isotactic (greater than 90% hot heptane insolubles) and has wide ranging melt flow rates (0.1-300 g/10 min). Additionally, the slip layer may include one or more, anti-cling (slip or antiblock) additives that may be added during polyolefin production blended in afterwards to improve the layer's slip properties. Such additives are well-known in the art and include, for example, silicas, silicates, diatomaceous earths, talcs, and various lubricants. These additives are typically used in amounts ranging from 100-20,000 ppm or 500-10,000 ppm by weight based upon the weight of the slip layer. The slip layer may, if desired, also include one or more other additives as described above.

Polymer products can be used for nonwovens, sealing layers, oriented polypropylene, and high-clarity thermoforming materials.

Low molecular weight varieties of high-pressure propylene homo- and co-polymers can be used for hot melt and pressure sensitive adhesives.

Invention processes can use finely divided, supported catalysts to prepare propylene/1-hexene copolymers with greater than 1.0 mole % hex-1-ene. In addition to finely divided supports, invention processes can use fumed silica supports in which the support particle size is small enough to form a colloid in the reaction media.

End Use Articles

Laminates comprising invention polymers can be used as a thermoformable sheet where the substrate is either sprayed or injection molded to couple it with the ionomer/tie-layer laminate sheet. The composite if formed into the desired shape to form the article, or composite article. Various types of substrate materials to form highly desirable articles. The laminate can be used with plastic substrates such as homopolymers, copolymers, foams, impact copolymers, random copolymers, and other applications. Specifically, some articles in which the present invention can be incorporated are the following: vehicle parts, especially exterior parts such as bumpers and grills, rocker panels, fenders, doors, hoods, trim, and other parts can be made from the laminates, composites and methods of the invention.

Other articles can also be made, for example, counter tops, laminated surface counter tops, pool liners, pool covers, boat covers, boat sails, cable jacketing, motorcycles, snowmobiles, outdoor vehicles, marine boat hulls, canoe interiors and exteriors, luggage, clothing, fabric (combined with non-wovens), tent materials, GORETEX, Gamma-radiation resistant applications, electronic housings (TV's, VCR's and computers), wood replacement for decks and other outdoor building materials, prefab buildings, synthetic marble panels for construction, wall coverings, hopper cars, floor coating, polymer-wood composites, vinyl tiles, bath, shower, toilet applications and translucent glass replacement, sidings, lawn and outdoor furniture, appliances such as refrigerators, washing machines, etc., child toys, reflective signage and other reflective articles on roads and clothing, sporting equipment such as snowboards, surfboards, skis, scooters, in-line skate wheels, scratch resistant CD's, stadium seats, aerospace reentry shields, plastic paper goods, sports helmets, plastic microwaveable cookware, and other applications for coating plastics and metal where a highly glossy and scratch resistant surface is desirable, while not being subject to algae or discoloration.

Invention copolymers are suitable for applications such as molded articles, including injection and blow molded bottles and molded items used in automotive articles, such as automotive interior and exterior trims. Examples of other methods and applications for making these polymers and for which these polymers may be useful are described in the Encyclopedia of Chemical Technology, by Kirk-Othmer, Fourth Edition, vol. 17, at pages 748-819. When the application is for molded articles, the molded articles may include a variety of molded parts, particularly molded parts related to and used in the automotive industry, such as for example bumpers, side panels, floor mats, dashboards and instrument panels. Foamed articles are another application and examples where foamed plastics, such as foamed polypropylene, are useful may be found in Encyclopedia of Chemical Technology, by Kirk-Othmer, Fourth Edition, vol. 11, at pages 730-783. Foamed articles are particularly useful for construction and automotive applications. Examples of construction applications include heat and sound insulation, industrial, and home appliances, and packaging. Examples of automotive applications include interior and exterior automotive parts, such as bumper guards, dashboards, and interior liners.

Invention polyolefin compositions are suitable for such articles as automotive components, wire and cable jacketing, pipes, agricultural films, geomembranes, toys, sporting equipment, medical devices, casting and blowing of packaging films, extrusion of tubing, pipes and profiles, sporting equipment, outdoor furniture (e.g., garden furniture) and playground equipment, boat and water craft components, and other such articles. In particular, the compositions are suitable for automotive components such as bumpers, grills, trim parts, dashboards and instrument panels, exterior door and hood components, spoiler, wind screen, hub caps, mirror housing, body panel, protective side molding, and other interior and external components associated with automobiles, trucks, boats, and other vehicles.

Other useful articles and goods may be formed economically by the practice of this invention include crates, containers, packaging, labware, such as roller bottles for culture growth and media bottles, office floor mats, instrumentation sample holders and sample windows; liquid storage containers such as bags, pouches, and bottles for storage and IV infusion of blood or solutions; packaging material including those for any medical device or drugs including unit-dose or other blister or bubble pack as well as for wrapping or containing food preserved by irradiation. Other useful items include medical tubing and valves for any medical device including infusion kits, catheters, and respiratory therapy, as well as packaging materials for medical devices or food which is irradiated including trays, as well as stored liquid, particularly water, milk, or juice, containers including unit servings and bulk storage containers as well as transfer means such as tubing, pipes, and such.

### EXAMPLES

### Catalyst Production

Synthesis of CH₂═CHCH₂C₅H₅ (L-1)

A Schlenk tube containing cyclopentadiene (40 ml, 0.60 mmol), allyl chloride (41 ml, 0.5 mol), nBu4NBr (2 g) and aqueous NaOH solution was stirred for 2 hrs at 0° C. It was then stirred at room temperature for another 4 hrs. The organic phase was separated and washed with water, and dried over K2CO3. With distillation, CH2=CHCH2C5H5 (L-1) (64-66° C./40 mmHg) was collected in 70% yield.

Synthesis of (CH₂═CH)MeSi(IndH)₂ (L-2)

LinBu (1.6M, 5 ml, 8.0 mmol) was added dropwise to indene (0.928 g, 8.0 mmol) in 100-ml Et2O. The solution turned orange-red. After stirring 2 hrs at room temperature, the solution was cooled to 0° C.; (CH2═CH)MeSiCl2 (4.0 mmol) was added dropwise. The solution was stirred for 2 more hrs. The orange-yellow solution was evaporated under reduced pressure, and the residue was chromatographed on silica gel (2.5×40 cm). Elution with CH2Cl2/hexane (2/1) gave yellow L-2 (0.84 g, 70.5%).

Synthesis of CH₂═CH(CH₂)ₙ(Me)Si(C₅H₅)₂ (n=0, L-3; n=1, L-4)

(CH2═CH)MeSiCl2 (1.0 ml, 7.66 mmol) was added to NaCp (15.32 mmol) in 50-ml DME. The reaction was stirred at room temperature for 30 hr and then evaporated. Column chromatography [eluted with CH2Cl2/hexane (2/1)] gave L-3 (1.18 g, 77.0%).

An analogous reaction between CH2═CHCH2(Me)SiCl2 (1.187 g, 7.66 mmol) and NaCp (15.32 mmol) give L-4 (0.90 g, 54.9%).

Synthesis f Me₂Si(3-CH₂═CHCH₂C₅H₄)₂ (L-5)

At −78° C. LinBu (1.6M, 10 ml, 16 mmol) was added to CH2═CHCH2C5H5 (L-1) (1.70 g, 16 mmol) in 150-ml Et2O. The solution immediately turned red. The reaction was stirred for 4 hrs and slowly warmed to 0° C.; Me2SiCl2 (1.032 g, 8.0 mmol) was added to the solution. After stirring 10 hrs at room temperature, the solvent was removed under vacuum, and the residue was chromatographed on silica. Elution with benzene/hexane (1/1) gave a yellow zone, which contained L-5 (1.40 g, 65.3%). L-5 was stored under argon at −25° C. before use.

Synthesis of Complex CH₂═CHCH₂Cp(Cp)MCl₂ [M=Ti(1a), Zr(1b), Hf(1c)]

1a. LinBu(1.6M, 3.13 ml, 5.0 mmol) was added to CH2═CHCH2C5H5 (L-1) (0.53 g, 5.0 mmol) in 50-ml THF at 0° C. The reaction was stirred at room temperature for 2 hrs. CpTiCl3 (1.12 g, 5.0 mmol) in 20-ml THF was added to that solution. After 8 hrs stirring at room temperature, the solution was evaporated under reduced pressure. The dark red residue was dissolved in 50-ml toluene and centrifuged to remove LiCl. Solvent evaporation gave a red solid, 1a, which was washed 3 times with hexane (10 ml). Recrystallization of 1a from toluene/hexane at −78° C. gave dark red needles (1.01 g, in 69.9% yield). Elemental analysis: Ti. 16.08% (calc. 16.57%), Cl. 24.2% (calc. 24.56%). IR(KBr pellet): 3077, 2916, 1636, 1487, 1382, 829 cm−1.

An analogous method was used for the preparation of 1b and 1c.

1b. Orange-red needles, 80.0% yield. Elemental analysis: Zr. 27.4% (calc. 27.44%), Cl 21.4% (calc. 21.33%). IR(KBr pellet): 3076, 2977, 1637, 1434, 1384, 816 cm−1.

1c. Yellow solid, 68% yield. Elemental analysis: Hf. 43.1% (calc. 42.54%), Cl. 16.8% (calc. 16.92%). IR(KBr pellet): 3062, 2965, 1638, 1439, 1382, 810 cm−1.

Synthesis of (CH₂═CH)MeSi(Ind)₂MCl₂ (M=Ti (2a), Zr (2b), Hf (2c))

2a. LinBu (1.6M, 5.0 ml, 8.0 mmol) was added dropwise to (CH2═CH)MeSi(IndH)2 (L-2) (1.19 g, 4.0 mmol) in 100-ml Et2O and stirred for 4 hrs. TiCl4 (0.76 g, 4.0 mmol) in 20-ml Et2O was added to that solution. After stirring 24 hrs at room temperature, the solvent was removed. The residue was extracted with 40-ml toluene. Recrystallization from benzene/hexane at −78° C. gave 1.10 g (66.3%) of dark red powder, complex 2a. Elemental analysis: Ti. 11.04% (calc. 11.47%), Cl. 16.2% (calc. 17.01%). IR(KBr pellet): 3056, 3011, 2915, 1620, 1512, 1452, 1382, 1280, 830 cm−1.

An analogous method was used for the preparation of 2b and 2c.

2b. Red microcrystals, 46.0% yield; Elemental analysis: Zr. 19.89% (calc. 19.80%), Cl. 14.9% (calc. 15.41%), C. 60.80% (calc. 54.76), H. 3.98% (calc. 3.94%). IR(KBr pellet): 3050, 2928, 1604, 1520, 1440, 1380, 1278, 824 cm−1. EI-MS (70 eV): 462(M+). 1H-NMR(CDCl3): δ 7.10-7.50 (m, 12H, Ind), 3.02 (m, 2H), 1.82 (t, 1H), 0.12 (s, 3H, SiMe). 2c. Yellow-orange powder, 36% yield. Elemental analysis: Hf. 32.20% (calc. 32.58%), Cl. 12.2% (calc. 12.95%). IR(KBr pellet): 3052, 2938, 1605, 1520, 1441, 1381, 1278, 821 cm−1.

Synthesis of CH₂═CH(Me)SiCp₂MCl₂ [M=Zr(3b), Hf(3c)]

LinBu(1.6M, 5.0 ml, 8.0 mmol) was added to CH2═CH(Me)Si(C5H5)2 (L-3) (0.80 g, 4.0 mmol) in 100-ml DME at 0° C., and then the mixture was stirred at room temperature for 4 hrs. ZrCl4 (0.93 g, 4.0 mmol) in 20-ml DME was added to that reaction. After stirring 24 hrs, the resulting red solution was filtered and dried under vacuum. The residue was extracted with 40-ml toluene. Recrystallization from benzene/hexane gave 1.3 g light-yellow prismatic crystals of 3b (90.4%). Elemental analysis: Zr. 25.66 (calc.25.30%), Cl. 19.91 (calc. 19.69%), C. 43.22(calc. 43.30%), H. 4.01(calc. 3.91); IR (KBr pellet): 3115, 3095, 3070, 2948, 2830, 1632, 1400, 1367, 1320, 1256, 1169, 980, 902, 846 cm−1; EI-MS (70 eV): m/e=360(M+, 10%), 324(M+−Cl, 100%); 1H-NMR (C6D6): δ 6.90 (t, 2H, 2C5H4-β-H), 6.85 (t, 2H, 2C5H4-β-H), 6.04(m, 1H, CH═), 5.92(m, 2H, CH2═), 5.69 (t, 2H, 2C5H4-α-H), 5.62 (t, 2H, 2C5H4-α-H), 0.25(s, 3H, SiMe).

An analogous method was used for the preparation of 3c.

3c. White crystals, 47% yield. Hf. 39.92%% (calc. 39.86%), Cl. 16.0% (calc. 15.86%). IR(KBr pellet): 3114, 3095, 3066, 2950, 2830, 1632, 1400, 1380, 1320, 1256, 1169, 980, 902, 846 cm−1.

Synthesis of CH₂═CHCH₂(Me)SiCp₂ZrCl₂ (3b-1)

The reaction was initiated by the dropwise addition of 1.0-ml (6.88 mmol) of allyldichloromethylsilane into a 50-ml DME solution (−78° C.) containing 13.76 mmol of freshly prepared C5H5Na. Then, the reaction mixture was stirred at room temperature overnight. The reaction mixture was cooled in EtOH/dry ice (frozen CO2) slush bath to −78° C., and 8.60-ml (13.76 mmol) of a 1.6M solution of nBuLi in hexane was added dropwise. The mixture was then warmed to room temperature and stirred for 24 h. Finally, the mixture was transferred to a DME solution of zirconium tetrachloride (1.604 g, 6.88 mmol) at room temperature and then was stirred for 48 h. The solvent was removed under vacuum, and the residue was dissolved in toluene. Filtering to remove Li salts and cooling the filtrate gave crystals of complex 3b-1 (colorless solid powder). Yield: 0.772 g (30%); IR (KBr, cm−1) 3105, 3091, 3068, 2997, 2967, 2899, 1626, 1400, 1369, 1360, 1323, 1261, 1170, 1156, 997, 926, 898; 1H-NMR (C6D6) δ 6.89 (2H, t, 2C5H4-βH), 6.85 (2H, t, 2C5H4-βH), 5.71 (1H, m, —CH═), 5.67 (2H, t, 2C5H4-αH), 5.63(2H, t, 2C5H4-αH), 5.02 (1H, m, CH2═), 4.99 (1H, m, CH2═), 1.77 (1H, d, —CH2—), 1.75(1H, d, —CH2—), 0.24(3H, s, SiCH3). Anal. Calcd. for C14H16SiZrCl2: C, 44.88; H, 4.28. Found: C, 45.15; H, 4.60.

Synthesis of Me₂Si(3-CH₂═CHCH₂Cp)₂ZrCl₂ (4b)

LinBu (1.6M, 3.13 ml, 5.0 mmol) reacted with Me2Si(3-CH2═CHCH2C5H4)2 (L-5) (0.67 g, 2.5 mmol) in 100-ml Et2O at −78° C. The reaction mixture was allowed to return to room temperature to stir 2 hrs. ZrCl4 (0.585 g, 2.5 mmol) in 40-ml Et2O was added to that solution. After stirring overnight, the resulting orange solution was evaporated under vacuum. The residue was extracted with 50-ml toluene and dried under vacuum to give 0.47 g of orange powder, 4b (43.8%). IR (KBr pellet): 3060, 2928, 1540, 1450, 1380, 1210, 810 cm−1. EI-MS (70 eV): m/e=428(M+).

Olefin Polymerization

Ethylene polymerizations used toluene or hexane as the solvent and used appropriate ethylene pressure. The polymerization vessel was a 500-ml glass reactor equipped with a propeller-like stirrer. Solvent (100 ml) was introduced into the argon-purged reactor and stirred (800 rpm). The solvent was heated to a prescribed polymerization temperature, and then, after 20 minutes, an ethylene gas feed was started. Adding a toluene solution of cocatalyst (MMAO) and then catalyst (as solid particles or dissolved in toluene) into the reactor with vigorous stirring (800 rpm) initiated polymerization. After a prescribed time, the ethylene gas feed was terminated. Alcohol (500 ml) and concentrated HCl (1 ml) were added to the resulting mixture. The polymer was collected by filtration, washed with methanol (100 ml), and dried under vacuum at 70° C. for 15 hours.

TABLE 1
Ethylene polymerization using metallocene catalysts
containing a free-radical-polymerizable group wherein these
data were collected before free-radical polymerization.

| | | | Activity(×10⁶ g |
|---|---|---|---|
| Catalyst | Al/M | T(° C.) | PE/mol · M · h) |
| CH₂═CHCH₂CpCpTiCl₂ | 1000 | 20 | 0.27 |
| | 1000 | 30 | 0.87 |
| | 1000 | 40 | 1.20 |
| | 1000 | 50 | 1.04 |
| | 1000 | 60 | 0.92 |
| | 200 | 40 | 0.29 |
| | 500 | 40 | 0.82 |
| | 1500 | 40 | 1.15 |
| | 2000 | 40 | 1.07 |
| CH₂═CHCH₂CpCpZrCl₂ | 1000 | 20 | 0.49 |
| | 1000 | 30 | 1.08 |
| | 1000 | 40 | 2.13 |
| | 1000 | 50 | 3.03 |
| | 1000 | 60 | 2.86 |
| | 200 | 50 | 0.77 |
| | 500 | 50 | 1.82 |
| | 1500 | 50 | 2.84 |
| | 2000 | 50 | 2.75 |

### Catalyst P lymerizati n

Synthesis of Polymerized CH₂═CHCH₂Cp(Cp)ZrCl₂ Catalysts (P-4)

AIBN (0.05 g) was added to a solution containing CH2═CHCH2Cp(Cp)ZrCl2 (1b) (1.40 g, 4.21 mmol), styrene (5 ml), and divinyl benzene (0.25 ml) in 150-ml toluene was stirred at 70° C. for 6 hrs. After reaction, the mixture was filtered, and the product was washed with toluene (3×20 ml) and hexane (2×20 ml) and dried under vacuum. ICP analysis: 4.0 mg Zr/g cat. GPC measurement indicated that molecular weight of P-4 is about 13000.

Synthesis of Polymerized 1,3-(CH₂═CHCH₂)₂Cp(Cp)ZrCl₂ Catalyst (P-16)

To a Schlenk tube, 1,3-(CH2═CHCH2)2Cp(Cp)ZrCl2 (1.45 g, 4.0 mmol), styrene (5 ml), AIBN (0.06 g) and 150-ml toluene was added and kept at 70° C. to stir for 5 hrs. After reaction, the mixture was filtered and polymer product was washed with hexane (3×20 ml) and dried under vacuum. ICP analysis: 6.2 mg Zr/g cat. GPC measurement indicated that molecular weight of P-16 is about 15000.

Using analogous preparation methods, the following polymerized catalysts were prepared.

| | |
|---|---|
| (CH₂═CHCH₂Cp)₂TiCl₂ | P-1 |
| CH₂═CHCH₂Cp(Cp)TiCl₂ | P-2 |
| (CH₂═CHCH₂Cp)₂ZrCl₂ | P-3 |
| CH₂═CHCH₂Cp(Cp)ZrCl₂ | P-4 |
| [CH₂═CHCH(Me)Cp]₂TiCl₂ | P-5 |
| CH₂═CHCH(Me)Cp(Cp)TiCl₂ | P-6 |
| [CH₂═CHCH(Me)Cp]₂ZrCl₂ | P-7 |
| CH₂═CHCH(Me)Cp(Cp)ZrCl₂ | P-8 |
| (p-CH₂═CHArCp)₂TiCl₂ | P-9 |
| (p-CH₂═CHArCp)(Cp)TiCl₂ | P-10 |
| (p-CH₂═CHArCp)2ZrCl₂ | P-11 |
| (p-CH₂═CHArCp)(Cp)ZrCl₂ | P-12 |
| CH₂═CHCH₂Cp(Cp*)TiCl₂ | P-13 |
| 1,3-(CH₂═CHCH₂)₂Cp(Cp)TiCl₂ | P-14 |
| CH₂═CHCH₂Cp(Cp*)ZrCl₂ | P-15 |
| 1,3-(CH₂═CHCH₂)₂Cp(Cp)ZrCl₂ | P-16 |

TABLE 2
Polymerized Metallocene Catalysts for Ethylene Polymerization

| | Catalyst | | | |
|---|---|---|---|---|
| | 1 | 2 | 3 | 4 |
| | P-4 | P-2 | BP-1 | BP-3 |
| Al/M molar ratio | 3000 | 7500 | 3000 | 3000 |
| Ethylene, psig | 60 | 15 | 150 | 150 |
| Temperature, ° C. | 80 | 25 | 85 | 85 |
| Time, min | 60 | 60 | 30 | 30 |
| Activity, 10⁶ g | 15.6 | 3 | 2.7 | 1.1 |
| PE/(mol · M · atm · hr) | | | | |
| Mw | | | 232,000 | 263,800 |
| Mn | | | 108,900 | 125,600 |
| Mw/Mn | | | 2.13 | 2.10 |

Catalyst 1: Polymerized CH₂═CHCH₂Cp(Cp)ZrCl₂ (from polymerizable catalyst 1b).
Catalyst 2: Polymerized CH₂═CHCH₂Cp(Cp)TiCl₂ (from polymerizable catalyst 1a).
Catalyst 3: Polymerized CH₂═CHCH₂Cp(Cp)ZrCl₂ (from polymerizable catalyst 1b) and CH₂═CHCH₂Cp(Cp*)ZrCl₂
Catalyst 4: Polymerized CH₂═CHCH₂Cp(Cp)ZrCl₂ (from polymerizable catalyst 1b) and CH₂═CHCH₂Cp(Cp)HfCl₂ (from polymerizable catalyst 1c).

Ethylene polymerization using polymerized metallocene catalysts with MAO in toluene solution is summarized below.

TABLE 3
Ethylene Polymerization Using
Polymerized Metallocene Catalysts.

| | | | Activity(×10⁶ g |
|---|---|---|---|
| Al/M | T(° C.) | Catalyst | PE/mol · M · h) |
| 1000 | 20 | (CH₂═CHCH₂Cp)₂TiCl₂ | 2.51 |
| | | CH₂═CHCH₂Cp(Cp)TiCl₂ | 2.87 |
| | | [CH₂═CHCH(Me)Cp]₂TiCl₂ | 2.56 |
| | | CH₂═CHCH₂Cp(Cp*)TiCl₂ | 1.52 |
| | | 1,3-(CH₂═CHCH₂)₂Cp(Cp)TiCl₂ | 3.21 |
| | 40 | CH₂═CHCH(Me)Cp(Cp)TiCl₂ | 7.20 |
| | | CH₂═CHCH₂Cp(Cp*)ZrCl₂ | 4.84 |
| | 50 | (CH₂═CHCH₂Cp)₂ZrCl₂ | 4.56 |
| | | CH₂═CHCH₂Cp(Cp)ZrCl₂ | 4.83 |
| | | [CH₂═CHCH(Me)Cp]₂ZrCl₂ | 5.08 |
| | | CH₂═CHCH(Me)Cp(Cp)ZrCl₂ | 5.51 |
| | | (p-CH₂═CHArCp)₂TiCl₂ | 2.82 |
| | | (p-CH₂═CHArCp)(Cp)TiCl₂ | 3.05 |
| | | (p-CH₂═CHArCp)₂ZrCl₂ | 3.69 |
| | | (p-CH₂═CHArCp)(Cp)ZrCl₂ | 4.20 |
| 1200 | 40 | 1,3-(CH₂═CHCH₂)₂Cp(Cp)ZrCl₂ | 5.73 |

Cp* is pentamethylcyclopentadienyl.

Synthesis of Polymerized Metallocene Catalysts That Contain Two Different Types of Metallocene Complexes in the Polymer Chain.

A solution containing CH2═CHCH2Cp(Cp)ZrCl2 (1.33 g, 4.0 mmol) and CH2═CHCH2Cp(Cp*)ZrCl2 (1.61 g, 4.0 mmol), styrene (0 ml), divinyl benzene (0.5 ml) and AIBN ( 0.06 g) in 120-ml toluene was kept at 70° C. and stirred for 60 hrs. After filtration and washing, solid powder product was collected. Polymerized bifuctional metallocene catalyst (BP-1) contains 2.91 mg Zr/g Cat. (ICP analysis).

Polymerized bifunctional metallocene catalysts with combination of CH2═CHCH2Cp(Cp)ZrCl2, CH2═CHCH2Cp(Cp)TiCl2 (BP-2) and CH2═CHCH2Cp(Cp)ZrCl2, CH2═CHCH2Cp(Cp)HfCl2 (BP-3) (containing 1.59 mg Zr/g cat and 6.42 mg Hf/g cat.) were also prepared by an analogous.

Ethylene Polymerization using BP-1, BP-2 and BP-3 in the presence of MAO under different condition were investigated and the results are given as following:

TABLE 4
Ethylene Polymerization using BP-1
Catalyst in the different ratio of Al/Zr

| Catalyst | Al/Zr (molar | | Activity (×10⁶ g |
|---|---|---|---|
| (mg) | ratio) | MAO (ml) | PE/mol · Zr · hr) |
| 29 | 1514 | 1 | 0.4885 |
| 26 | 2132 | 1.5 | 0.8681 |
| 28 | 3134 | 2 | 1.074 |
| 26 | 3918 | 2.5 | 0.581 |
| 28 | 4702 | 3 | 0.578 |

T: 25° C.;
Element analysis: Zr, 2.91 mg/g cat.

TABLE 5
Ethylene Polymerization Using BP-1
Catalyst At Various Temperatures.

| Temperature (° C.) | Activity(×10⁶ g PE/mol · Zr · hr) |
|---|---|
| 25 | 1.074 |
| 35 | 1.157 |
| 45 | 1.548 |
| 55 | 1.036 |
| 65 | 1.027 |

Element analysis: Zr, 2.91 mg/g cat.; Al/Zr: 3134

TABLE 6
Ethylene Polymerization Using BP-3
Catalyst At Various Al/Zr Ratios.

| | Al/Zr (molar | | Activity (×10⁶ g |
|---|---|---|---|
| Cat. (mg) | ratio) | MAO (ml) | PE/mol · Zr · hr) |
| 34 | 1542 | 1 | 0.263 |
| 37 | 2834 | 2 | 0.420 |
| 36 | 3641 | 2.5 | 0.427 |
| 38 | 4139 | 3 | 0.687 |
| 34 | 5397 | 3.5 | 0.375 |
| 38 | 6209 | 4.5 | 0.285 |

T: 25° C.,
Element analysis: Zr, 1.59 mg/g cat, Hf, 6.42 mg/g cat.

TABLE 7
Ethylene Polymerization Using BP-3
Catalyst At Different Temperatures

| Temperature (° C.) | Activity (×10⁶ g PE/mol · Zr · hr) |
|---|---|
| 25 | 0.687 |
| 35 | 0.375 |
| 45 | 0.085 |
| 55 | 0.187 |
| 65 | 0.260 |

Element analysis: Zr, 1.59 mg/g cat, Hf, 6.42 mg/g cat. Al/Zr: 4139

Ethylene slurry polymerization using polymerized [(CH2═CHCH2Cp)2ZrCl2] metallocene catalyst and MAO was studied.

TABLE 8
Result of Ethylene Polymerization with Polymerized
[(CH₂═CHCH₂Cp)₂ ZrCl₂] under High Ethylene Pressure.

| | | |
|---|---|---|
| Activity (×10⁷ g PE/mol·M) | 1.84 | 6.48 |
| Bulk density (g/cm³) | 0.327 | 0.341 |
| Mw | 180000 | 167000 |
| Mw/Mn | 3.0 | 2.7 |
| Density (g/cm³) | 0.934 | 0.917 |
| Melting point(° C.) | 126.1 | 128.2 |
| ΔHm | 35.66 cal/g, | 38.7 cal/g, |
| | 149.27 J/g | 159.4 J/g |
| MI_{21.6} | 0.8 | |
| Tensile yield Strength | 15 | |
| (MPa) | | |
| Tensile break strength | 36 | |
| (MPa) | | |
| Elongation at break (%) | 860 | |

Condition: 1.4 MPa, 70° C., 2 L autoclave.

While certain representative embodiments and details have been shown to illustrate the invention, it will be apparent to skilled artisans that various process and product changes from those disclosed in this application may be made without departing from this invention's scope, which the appended claims define.

All cited patents, test procedures, priority documents, and other cited documents are fully incorporated by reference to the extent that this material is consistent with this specification and for all jurisdictions in which such incorporation is permitted.

Certain features of the present invention are described in terms of a set of numerical upper limits and a set of numerical lower limits. This specification discloses all ranges formed by any combination of these limits. All combinations of these limits are within the scope of the invention unless otherwise indicated.

We claim:

1. A composition comprising the product of combining, in the presence of a free radical initiator, a catalyst precursor and at least one monomer wherein the monomer is polymerizable by free-radical polymerization, and wherein the catalyst precursor is represented by one of the formulas: 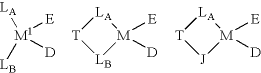
wherein
(a) M is a Group 3-10 metal;
M¹ is a Group 3-10 metal;
(b) L_{A} is a substituted or unsubstituted, cyclopentadienyl or heterocyclopentadienyl ligand connected to M wherein L_{A} comprises R;
(C) L_{B} is
(i) a ligand as defined for LA but selected independently of L_{A}, or
(ii) J, a heteroatom ligand connected to M, wherein J comprises a Group-14-15 atom and 0-2 of R″;
(d) T is a bridging group that connects L_{A} and L_{B} and comprises a Group-13-to-16 element and 0-2 of R″; and
(e) D and E are the same or different abstractable ligands,
wherein each R, R′, and R″ are independently selected from hydrogen or a hydrocarbyl group provided at least one of R, R′, and R″ can be polymerized by a free radical initiator, provided that when M¹ is Zr, L_{A} is substituted at more than one carbon atom.

2. The composition of claim 1 wherein each R, R′, and R″ are independently selected from hydrogen or a C₁-C₅₀ hydrocarbyl group.

3. The composition of claim 1 wherein each R, R′, and R″ are independently selected from hydrogen or a C1-C20 hydrocarbyl group.

4. The composition of claim 3 wherein each R is independently one of hydrogen, allyl, methyl, or phenyl groups.

5. The composition of claim 3 wherein M is selected from a Group-3-7 transition metal.

6. The composition of claim 5 wherein M is selected from a Group-3-4.

7. The composition of claim 3 wherein the abstractable ligands are independently hydride radicals; hydrocarbyl radicals; or hydrocarbyl-substituted, organometalloid radicals.

8. The composition of claim 7 wherein two abstractable ligands join to form a 3-to-40-atom metallacycle ring.

9. The composition of claim 3 wherein abstractable ligands are independently halogen, alkoxide, aryloxide, amide, or phosphide radicals.

10. The composition of claim 3 wherein abstractable ligands are chloride, bromide, iodide, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, hydride, phenyl, benzyl, phenethyl, tolyl, methoxy, ethoxy, propoxy, butoxy, dimethylamino, diethylamino, methylethylamino, phenoxy, benzoxy, allyl, 1,1-dimethyl allyl, 2-carboxymethyl allyl, acetylacetonate, 1,1,1,5,5,5-hexa-fluoroacetylacetonate, 1,1, 1-trifluoroacetylacetonate, or 1,1,1-trifluoro-5,5-di-methylacetylacetonate radicals.

11. The composition of claim 3 wherein at least one abstractable ligand is chloride.

12. The composition of claim 1 wherein the at least one monomer comprises styrene, vinyl styrene, alkyl styrene, isobutylene, isoprene, or butadiene.

13. The composition of claim 12 wherein the one or more monomers comprise styrene.

14. The composition of claim 1 wherein the free radical initiator is selected from azo initiators or peroxides.

15. The composition of claim 3 wherein the free radical initiator is selected from dialkyldiazenes, hyponitrites, diacyl peroxides, dialkyl peroxydicarbonates, peresters, alkyl hydroperoxides, dialkyl peroxides, or inorganic peroxides.

16. The composition of claim 15 wherein the free radical initiator is selected from 2,2′-azobis(2-methylpropanenitrile), 1,1-azobis(1-cyclohexanenitrile), 4,4′-azobis(4-cyanovaleric acid), triphenylmethylazobenzene, di-t-butyl hyponitrite, dicumyl hyponitrite, dibenzoyl peroxide, didodecanoyl peroxide, diacetyl peroxide, diisopropyl ester, dicyclohexyl ester, cumyl hydroperoxide, t-butyl hydroperoxide, dicumyl peroxide, di-t-butyl peroxide, hydrogen peroxide, and persulfate initiators.

17. A catalyst system comprising the reaction product of the composition of claim 1 and an activator.

18. The catalyst system of claim 17 wherein the activator is selected from alumoxanes, aluminum alkyls, alkyl aluminum halides, alkylaluminum alkoxides, discrete ionic activators, and Lewis acid activators.

19. The catalyst system of claim 18 wherein the activator is selected from methylalumoxane, modified methylalumoxane, ethylalumoxane, trimethyl aluminum, triethyl aluminum, triisopropyl aluminum, diethyl aluminum chloride, alkylaluminum alkoxides, ammonium borate salts, phosphonium borate salts, triphenyl carbenium borate salts, ammonium aluminate salts, phosphonium aluminate salts, triphenyl carbenium aluminate salts, trisarylborane acids, and polyhalogenated heteroborane anions.

20. The composition of claim 1 wherein the catalyst precursor is represented by one of the following formulas: 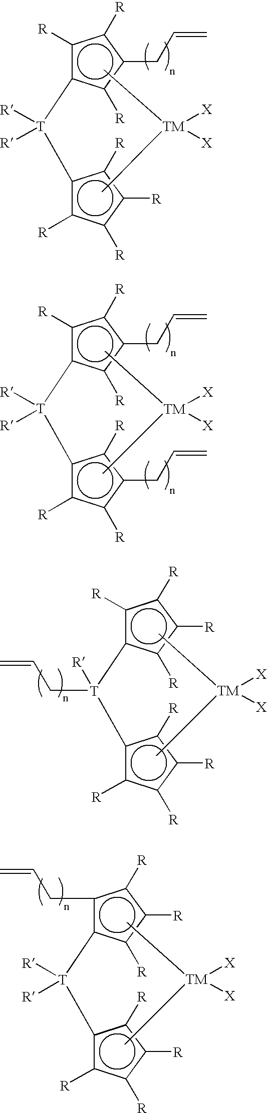 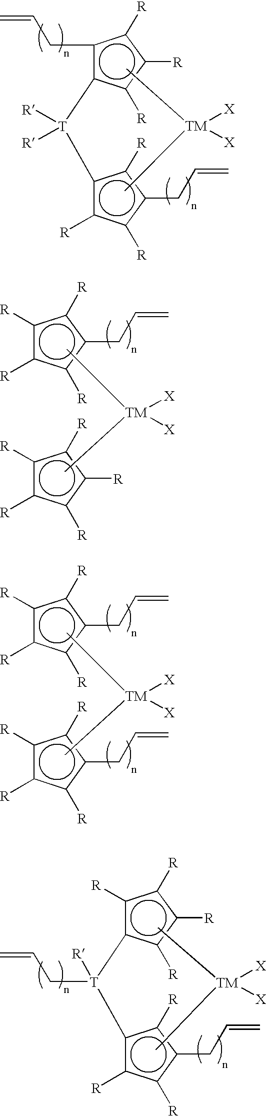 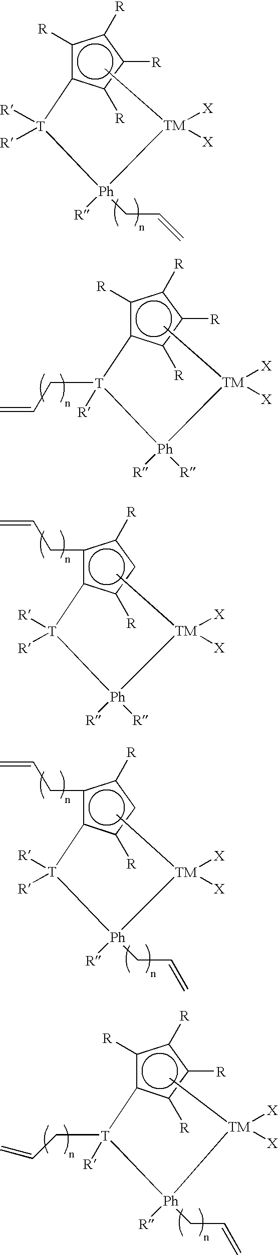 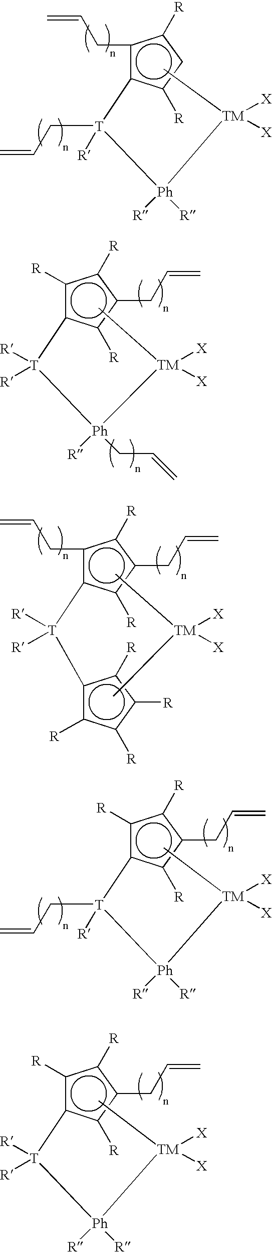 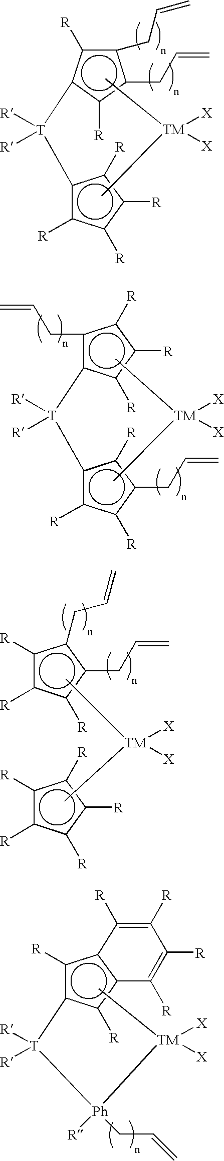 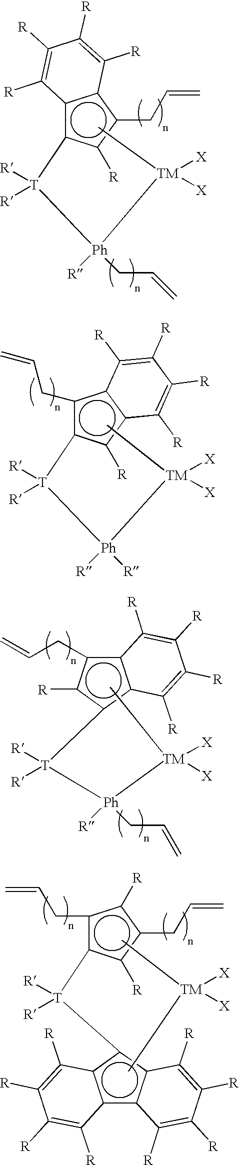 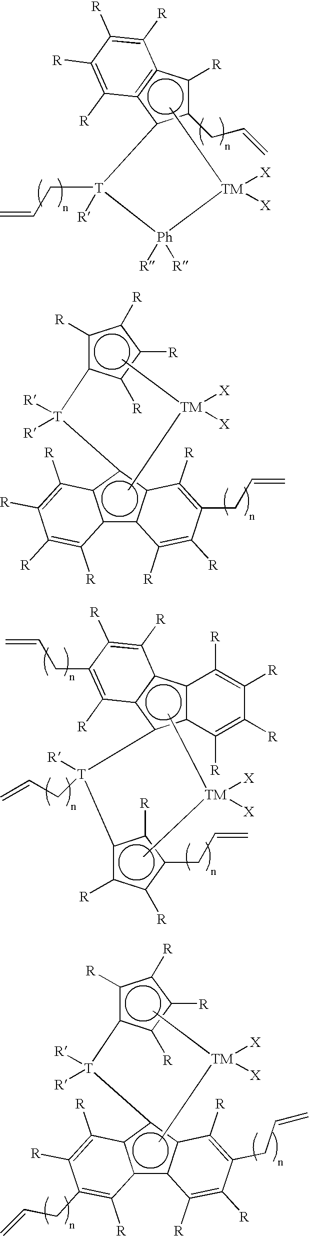 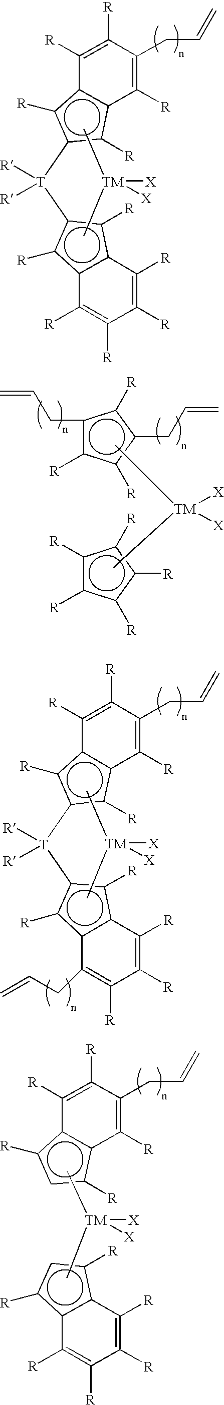 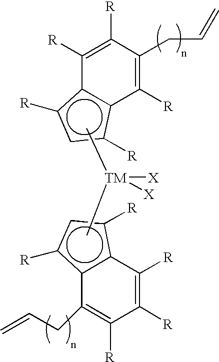
wherein
(a) X are the same or different abstractable ligand;
(b) Each R, R′, and R″ are independently selected from hydrogen or a hydrocarbyl group provided at least one of R, R′, and R″ can be polymerized by a free radical initiator;
(c) TM is a Group-4-11 metal;
(d) n is 0-3; and
(e) Pn is a Group-14-15 atom.

21. An olefin polymerization method comprising the steps of combining an olefin with the composition of claim 1, and an activator.

22. An olefin polymerization method comprising combining the compositional claim 3 with an olefin and an activator, where
(a) the olefin monomer, and the catalyst and the activator are combined under polymerization conditions comprising:
(i) slurry polymerization conditions wherein slurry polymerization conditions comprise:
a reaction temperature of 0-120° C.;
a reaction pressure of 103-5068 kPa gauge;
a reaction media selected from C3-C7 alkanes; and
a primary monomer concentration of 1-10 wt % based on the total weight of monomer plus media;
(ii) gas-phase polymerization conditions wherein gas-phase polymerization conditions comprise:
a reaction temperature of 30-120° C.;
a reaction pressure of 69 kPa-3.5 MPa gauge; and
a primary monomer partial pressure of 138 kPa-2.1 MPa;
or
(iii) solution polymerization conditions wherein solution polymerization conditions comprise:
a reaction temperature of 0-120° C.;
a reaction pressure of 103-5068 kPa; and
a solvent selected from toluene, benzene, xylene, or hexane.
